(19) United States
(12) Patent Application Publication
(10) Pub. No.: US 2006/0280894 A1
(43) Pub. Date: Dec. 14, 2006

(54) Metal complexes as light-absorbing compounds in the information layer of optical data carriers

(76) Inventors: Horst Berneth, Leverkusen (DE); Friedrich-Karl Bruder, Krefeld (DE); Rainer Hagen, Leverkusen (DE); Karin Hassenruck, Duseldorf (DE); Sergusi Kostromine, Swisttal (DE); Christa Maria Kruger, Schneverdingen (DE); Timo Meyer-Friedrichsen, Krefeld (DE); Rafael Oser, Krefeld (DE); Josef-Walter Stawitz, Odenthal (DE)

Correspondence Address: Lanxess Corporation;Law & Intellectual Property Department, 111 Ridc Park West Drive, Pittsburgh, PA, 15275-1112, US

(21) Appl. No.: 10/544,679

(22) PCT Filed: Jan. 31, 2004
(86) PCT No.: PCT/EP04/00878

§ 371 Date: Jul. 24, 2006

(30) Foreign Application Priority Data
Feb. 13, 2003 (DE) 103 05 924.5

(51) Int. Cl. B32B 3/02

(52) U.S. Cl. 428/64.4

(57) ABSTRACT

The invention provides novel metal complexes for optical data carriers comprising a preferably transparent substrate which may, if desired, have previously been coated with one or more reflection layers and to whose surface a light-writable information layer, if desired one or more reflection layers and if desired a protective layer or a further substrate or a covering layer have been applied, which can be written on and read by means of blue or red light, preferably laser light, where the information layer comprises a light-absorbent compound and, if desired, a binder, characterized in that at least one of the abovementioned metal complexes is used as light-absorbent compound.

The invention relates to metal complexes, to a process for preparing them, to the azo compounds functioning as ligands in the metal complexes and their preparation, to the coupling components on which the azo compounds are based and their preparation, to optical data stores comprising the metal complexes in their information layer and also the application of the abovementioned dyes to a polymer substrate, in particular polycarbonate, by spin coating or vapor deposition.

Write-once optical data carriers using specific light-absorbent substances or mixtures thereof are particularly suitable for use in high-density writeable optical data stores which operate with blue laser diodes, in particular GaN or SHG laser diodes (360-460 nm) and/or for use in DVD-R (DVD-R, DVD+R) or CD-R disks which operate with red (635-660 nm) or infrared (780-830 nm) laser diodes.

The write-once compact disk (CD-R, 780 nm) has recently experienced enormous volume growth and represents the technically established system.

The next generation of optical data stores—DVDs—is currently being introduced onto the market. Through the use of shorter-wave laser radiation (635-660 nm) and higher numerical aperture NA, the storage density can be increased. The writeable format in this case is DVD-R

Today, optical data storage formats which use blue laser diodes (based on GaN, JP 08 191 171 or Second Harmonic Generation SHG JP 09050 629) (360 nm-460 nm) with high laser power are being developed. Writeable optical data stores will therefore also be used in this generation. The achievable storage density depends on the focussing of the laser spot on the information plane. Spot size scales with the laser wavelength λ/NA. NA is the numerical aperture of the objective lens used. In order to obtain the highest possible storage density, the use of the smallest possible wavelength λ is the aim. At present 390 nm is possible on the basis of semiconductor laser diodes.

The patent literature describes dye-based writeable optical data stores which are equally suitable for CD-R and DVD-R (DVD-R, DVD+R) systems (JP-A 11 043 481 and JP-A 10 181 206). To achieve a high reflectivity and a high modulation height of the read-out signal and also to achieve sufficient sensitivity in writing, use is made of the fact that the IR wavelength of 780 nm of CD-Rs is located at the foot of the long wavelength flank of the absorption peak of the dye and the red wavelength of 635 nm or 650 nm of DVD-Rs (DVD-R, DVD+R) is located at the foot of the short wavelength flank of the absorption peak of the dye. In JP-A 02 557 335, JP-A 10 058 828, JP-A 06 336 086, JP-A 02 865 955, WO-A 09 917 284 and U.S. Pat. No. 5,266,699, this concept is extended to the 450 nm working wavelength region on the short wavelength flank and the red and IR region on the long wavelength flank of the absorption peak.

Apart from the abovementioned optical properties, the writeable information layer comprising light-absorbent organic substances has to have a substantially amorphous morphology to keep the noise signal during writing or reading as small as possible. For this reason, it is particularly preferred that crystallization of the light-absorbent substances be prevented in the application of the substances by spin coating from a solution, by vapor deposition and/or sublimation during subsequent covering with metallic or dielectric layers under reduced pressure.

The amorphous layer comprising light-absorbent substances preferably has a high heat distortion resistance, since otherwise further layers of organic or inorganic material which are applied to the light-absorbent information layer by sputtering or vapor deposition would form blurred boundaries due to diffusion and thus adversely affect the reflectivity. Furthermore, a light-absorbent substance which has insufficient heat distortion resistance can, at the boundary to a polymeric support. diffuse into the latter and once again adversely affect the reflectivity.

A light-absorbent substance whose vapor pressure is too high can sublime during the above-mentioned deposition of further layers by sputtering or vapor deposition in a high vacuum and thus reduce the layer thickness to below the desired value. This in turn has an adverse effect on the reflectivity.

It is therefore an object of the invention to provide suitable compounds which satisfy the high requirements (e.g. light stability, favorable signal/noise ratio, damage-free application to the substrate material, and the like) for use in the information layer in a write-once optical data carrier, in particular for high-density writeable optical data-store formats in a laser wavelength range from 340 to 680 nm.

It has surprisingly been found that light-absorbent compounds selected from among a group of specific metal complexes can satisfy the abovementioned requirement profile particularly well.

The invention accordingly provides metal complexes which have at least one ligand of the formula (I) 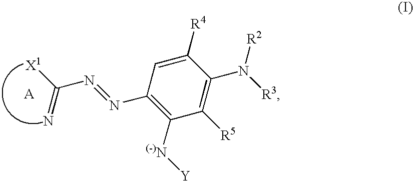
where
X¹ is O, S, N—R¹ or CH,
A together with X¹ and N forms a five- or six-membered aromatic or pseudoaromatic heterocyclic ring which contains from 1 to 4 heteroatoms and/or can be benzo- or naphtho-fused and/or be substituted by nonionic radicals,
R¹ is hydrogen, substituted or unsubstituted C₁—C₁₂-alkyl, substituted or unsubstituted C₃-C₈-cycloalkyl, substituted or unsubstituted C₂-C₁₂-alkenyl or substituted or unsubstituted C₇-C₁₂-aralkyl,
R² and R³ are each, independently of one another, hydrogen, substituted or unsubstituted C₁-C₁₂-alkyl, substituted or unsubstituted C₃-C₈-cycloalkyl, substituted or unsubstituted C₂-C₁₂-alkenyl, substituted or unsubstituted C₂-C₁₂-alkynyl, substituted or unsubstituted C₇-C₁₂-aralkyl, substituted or unsubstituted C₆-C₁₀-aryl or a five- or six-membered heterocyclic ring or
NR²R³ together with the nitrogen atom is a five- to seven-membered heterocyclic ring which may contain further heteroatoms and/or be substituted by nonionic radicals,
R⁴ and R⁵ are each, independently of one another, hydrogen, halogen, substituted or unsubstituted C₁-C₆-alkyl, substituted or unsubstituted C₁-C₆-alkoxy or substituted or unsubstituted C₁-C₆-alkylthio or
R²; R⁴ and R³; R⁵ are each, independently of one another, a divalent to tetravalent bridge which may contain further heteroatoms and/or be substituted by nonionic radicals,
Y is SO₂—Y¹ or POY²Y³,
Y¹ is —O—R⁶, —NH—R⁶ or NR⁶R⁷,
Y² and Y³ are each, independently of one another, substituted or unsubstituted C₁-C₁₂-alkyl, substituted or unsubstituted C₆-C₁₀-aryl, a substituted or unsubstituted five- or six-membered pseudoaromatic or aromatic heterocyclic radical, —O—R⁶, —NH—R⁶ or NR⁶R⁷, or Y² and Y³ together form a bridge,
R⁶ and R⁷ are each, independently of one another, substituted or unsubstituted C₁-C₁₂-alkyl, substituted or unsubstituted C₃-C₈-cycloalkyl, substituted or unsubstituted C₂-C₁₂-alkenyl, substituted or unsubstituted C₂-C₁₂-alkynyl, substituted or unsubstituted C₇-C₁₂-aralkyl, substituted or unsubstituted C₆-C₁₀-aryl or a five- or six-membered heterocyclic ring or
NR⁶R⁷ together with the nitrogen atom is a five- to seven-membered heterocyclic ring which may contain further heteroatoms and/or be substituted by nonionic radicals,
   or metal complexes which have at least one ligand of the formula (LI) 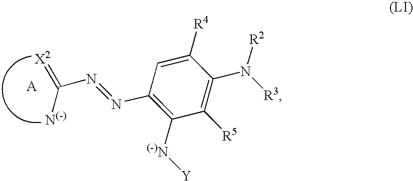
   where
X² is N or CH
   and the other radicals are as described above.

In a preferred embodiment, the metal complexes are in the form of 1:1 or 1:2 metal:azo complexes.

Particular preference is given to metal complexes containing two identical or different ligands of the formula (I).

Particular preference is given to metal complexes containing two identical or different ligands of the formula (LI).

Preference is given to metal complexes which are characterized in that they have the formula (Ia)
[(I)]₂⁻M²⁺ (Ia)
where the two ligands of the formula (I) have, independently of one another, one of the meanings given above and
M is a metal.

Preference is likewise given to metal complexes which are characterized in that they have the formula (Ib)
[(I)]₂⁻M³⁺An⁻ (Ib)
where the two ligands of the formula (I) have, independently of one another, one of the meanings given above and
M is a metal and
An⁻ is an anion.

Preference is likewise given to random mixtures of metal complexes which are characterized in that they contain two different ligands of the formula I.

Preferred metals are divalent metals, transition metals or rare earths, in particular Mg. Ca, Sr, Ba, Cu, Ni, Co, Fe, Zn, Pd, Pt, Ru, Th, Os, Sm, Eu. Preference is given to the metals Pd, Fe, Zn, Cu, Ni and Co. Particular preference is given to Ni and Zn.

Further preferred metals are trivalent metals, transition metals or rare earths. In this case, the excess third charge of the metal is balanced by an anion. Particularly useful metals of this type are B, Al, Ga, In, V, Co, Cr, Fe, Y, La, Ce, Pr, Nd, Sm, Eu, Gd, Tb. Preference is given to B, Al, Co. Particular preference is given to Co.

Nonionic radicals are, for example, halogen, alkyl, alkenyl, aralkyl, aryl, alkoxy, alkylthio, hydroxy, amino, alkylamino, dialkylamino, cyano, nitro, alkoxycarbonyl, alkylamino or dialkylaminocarbonyl, —C(═NH)—O-alkyl, alkanoyl, aroyl, alkylsulfonyl, arylsulfonyl.

Possible substituents on the alkyl, alkoxy, alkylthio, cycloalkyl, aralkyl, aryl or heterocyclic radicals are halogen, in particular Cl or F, nitro, cyano, hydroxy, CO—NH₂, CO—O-alkyl or alkoxy. The alkyl radicals can be linear or branched and they can be partially halogenated or perhalogenated. Examples of substituted alkyl radicals are trifluoromethyl, chloroethyl, cyanoethyl, methoxyethyl. Examples of branched alkyl radicals are isopropyl, tert-butyl, 2-butyl, neopentyl.

Preferred substituted and unsubstituted C₁-C₁₂-alkyl radicals are methyl, ethyl, n-propyl, isopropyl, n-butyl, 2-butyl, isobutyl, tert-butyl, n-pentyl, n-hexyl, octyl, decyl, dodecyl, perfluorinated methyl, perfluorinated ethyl, 3,3,3-trifluoroethyl, 2,2,3,3-tetrafluoropropyl, perfluorobutyl, cyanoethyl, methoxyethyl.

Examples of preferred aralkyl groups are benzyl, phenethyl and phenylpropyl.

Preferred heterocyclic radicals are furyl, thienyl, thiazolyl, benzothiazolyl, oxazolyl, benzoxazolyl; imidazolyl, benzimidazolyl, pyridyl, pyrimidyl, pyrazinyl, quinolyl, which may each be substituted by methyl, methoxy, chloro. cyano, nitro or methoxycarbonyl.

Possible anions An⁻ are all monovalent anions or one equivalent of a polyvalent anion or one equivalent of an oligomeric or polymeric anion. The anions are preferably colorless. Examples of suitable anions are chloride, bromide, iodide, nitrate, tetrafluoroborate, perchlorate, hexafluorosilicate, hexafluorophosphate, methosulfate, ethosulfate, C₁-C₁₀-alkanesulfonate, C₁-C₁₀-perfluoroalkanesulfonate, unsubstituted or chloro-, hydroxy- or C₁-C₄-alkoxy-substituted C₁-C₁₀-alkanoate, unsubstituted or nitro-, cyano-, hydroxy-, C₁-C₂₅-alkyl-, perfluoro-C₁-C₄-alkyl-, C₁-C₄-alkoxycarbonyl- or chloro-substituted benzenesulfonate or naphthalenesulfonate or biphenylsulfonate, unsubstituted or nitro-, cyano-, hydroxy-, C₁-C₄-alkyl-, C₁-C₄-alkoxy-, C₁-C₄-alkoxycarbonyl- or chloro-substituted benzenedisulfonate or naphthalenedisulfonate or biphenyldisulfonate, unsubstituted or nitro-, cyano-, C₁-C₄-alkyl-, C₁-C₄-alkoxy-, C₁-C₄-alkoxycarbonyl-, benzoyl-, chlorobenzoyl- or toluoyl-substituted benzoate, the anion of naphthalenedicarboxylic acid, diphenyl ether disulfonate, tetraphenylborate, cyanotriphenylborate, tetra-C₁-C₂₀-alkoxyborate, tetraphenoxyborate, 7,8- or 7,9-dicarbaundecaborate(1-) or (2-), which may each be substituted by one or two C₁-C₁₂-alkyl or phenyl groups on the B and/or C atoms, dodecahydro-dicarbadodecaborate(2-) or B—C₁—C₁₂-alkyl-C-phenyldodecahydro-dicarbadodecaborate(1-), polystyrenesulfonate, poly(meth)acrylate, polyallylsulfonate.

Preference is given to bromide, iodide, tetrafluoroborate, perchlorate, hexafluorophosphate, methanesulfonate, trifluoromethanesulfonate, benzene-sulfonate, toluenesulfonate, dodecylbenzenesulfonate, tetradecanesulfonate, polystyrenesulfonate.

Further possible anions An⁻ are all monovalent anions or one equivalent of a polyvalent anion of a dye. The anionic dye An⁻ preferably has an absorption spectrum similar to that of the cationic azo metal salt. Examples of suitable anionic dyes are anionic azo dyes, anthraquinone dyes, porphyrins, phthalocyanines, subphthalocyanines, cyanines, merocyanines, rhodamines, metal complexes and oxonols.

The metal complexes of the formula (Ia) presumably have the formula (II) 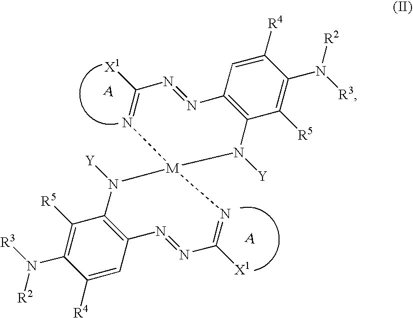
where M and the radicals of the respective azo ligands have, independently of one another, the meanings given above. For the purposes of the present patent application, it will be assumed that the formulae (II) and (Ia) characterize the same compounds.

Particular preference is given to metal complexes of ligands of the formula (I), in particular complexes of the formula (Ia) or (Ib), in which
the ring A of the formula (III) 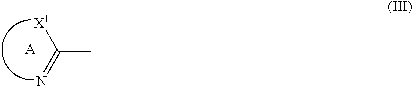
is benzothiazol-2-yl, benzoxazol-2-yl, benzimidazol-2-yl, thiazol-2-yl, thiazol-4-yl, imidazol-2-yl, pyrazol-5-yl, 1,3,4-thiadiazol-2-yl, 1,2,4-thiadiazol-5-yl, 1,2,4-thiadiazol-3-yl, 1,3,4-oxadiazol-2-yl, 1,3,4-triazol-2-yl, 2-pyridyl, 2-quinolyl, 3-pyridazinyl, 2-pyrimidyl, 1,3,5-triazin-2-yl or 2-pyrazinyl, which may each be substituted by C₁-C₆-alkyl, C₁-C₆-alkoxy, fluorine, chlorine, bromine, iodine, cyano, —C(═NH)—O—C₁-C₆-alkyl, nitro, C₁-C₆-alkoxycarbonyl, C₁-C₆-alkylthio, C₁-C₆-acylamino, formyl, C₂-C₆-alkanoyl, C₆-C₁₀-aryl, C₆-C₁₀-aryloxy, C₆-C₁₀-arylcarbonylamino, mono- or di-C₁-C₆-alkylamino, N—C₁-C₆-alkyl-N—C₆-C₁₀-arylamino, pyrrolidino, morpholino, piperazino or piperidino,
   where
   X¹ is O, S, N—R¹ or CH,
R¹ is hydrogen, C₁-C₄-alkyl, allyl or C₇-C₉-aralkyl,
Y is SO₂—Y¹ or POY²Y³,
Y¹ is —O—R⁶, —NH—R⁶ or NR⁶R⁷,
Y² and Y³ are each, independently of one another, methyl, ethyl, trifluoromethyl, 2,2,2-trifluoroethyl, 2,2-difluoroethyl, phenyl, tolyl, —O—R⁶, —NH—R⁶ or NR⁶R⁷, or Y² and Y³ together form a —(CH₂)₄—, —(CH₂)₅— or —CH₂—CH═CH—CH₂— bridge,
R⁶ and R⁷ are each, independently of one another, unsubstituted or fluoro-, chloro-, hydroxy-, methoxy-, ethoxy- or cyano-substituted C₁-C₈-alkyl, C₅-C₆-cycloalkyl, allyl, unsubstituted or chloro-, methyl- or methoxy-substituted C₇-C₉-aralkyl, unsubstituted or fluoro-, chloro-, hydroxy-, methoxy-, ethoxy-, nitro- or cyano-substituted phenyl or pyridyl or
NR⁶R⁷ is pyrrolidino, piperidino or morpholino,
   and all other radicals are as defined above.

Very particular preference is given to metal complexes of ligands of the formula (I), in particular complexes of the formula (Ia),

in which

the ring A of the formula (III) 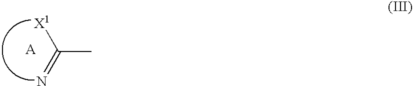
is benzothiazol-2-yl which may bear up to three identical or different radicals selected from the group consisting of chloro, methyl, methoxy, ethoxy, cyano and nitro as substituents, benzimidazol-2-yl which may bear up to three identical or different radicals selected from the group consisting of chloro, methyl, methoxy, ethoxy, cyano and nitro as substituents, thiazol-2-yl which may bear up to two identical or different radicals selected from the group consisting of chloro, fluoro, methyl, trifluoromethyl, methoxy, phenyl, cyano, nitro, methoxycarbonyl, methanesulfonyl, formyl and the divalent radical of the formula —CH₂)₄— as substituents, thiazol-4-yl which may bear up to two identical or different radicals selected from the group consisting of chloro, fluoro, methoxy, methylthio, phenyl and cyano as substituents, imidazol-2-yl which may bear up to two identical or different radicals selected from the group consisting of fluoro, chloro. methyl, trifluoromethyl, methoxy, phenyl, cyano, nitro, CH₃O—(C═NH)—, methoxycarbonyl and ethoxycarbonyl as substituents, pyrazol-5-yl which may bear up to two identical or different radicals selected from the group consisting of chloro, methyl, methoxy, phenyl, cyano and nitro as substituents, 1,3,4-thiadiazol-2-yl which may bear a chloro, bromo, methoxy, phenoxy, methanesulfonyl, methylthio, ethylthio, dimethylamino, diethylamino, di(iso)propylamino, N-methyl-N-cyanoethylamino, N,N-biscyanoethylamino, N-methyl-N-hydroxyethylamino, N-methyl-N-benzylamino, N-methyl-N-phenylamino, anilino, pyrrolidino, piperidino or morpholino substituent, 1,2,4-thiadiazol-5-yl which may bear a chloro, methyl, methoxy, phenoxy, methylthio, methanesulfonyl, phenyl, dimethylamino or anilino substituent, 1,2,4-thiadiazol-3-yl which may bear a methyl or phenyl substituent, 1,3,4-triazol-2-yl which may bear a methyl or phenyl substituent, 2-pyridyl which may bear chloro, methyl, methoxy, cyano, methoxycarbonyl or nitro substituents, 2-quinolyl which may bear chloro, methyl, methoxy, cyano, methoxycarbonyl or nitro substituents, 2-pyrimidyl which may bear up to three identical or different radicals selected from the group consisting of chloro, methyl, methoxy, cyano, methoxycarbonyl and nitro as substituents, 1,3,5-triazin-2-yl or 2-pyrazinyl,
   where
   X¹ is O, S, N—R¹ or CH,
R¹ is hydrogen, methyl, ethyl, propyl, butyl, allyl, benzyl, phenethyl or phenylpropyl,
R² and R³ are each, independently of one another, hydrogen, methyl, ethyl, propyl, butyl, hydroxyethyl, cyanoethyl, cyclopentyl, cyclohexyl, allyl, benzyl, phenethyl, phenylpropyl, phenyl, tolyl, chlorophenyl or anisyl or
NR²R³ is pyrrolidino, piperidino or morpholino,
R⁴ is hydrogen, chlorine, methyl, methoxy or methylthio,
R⁵ is hydrogen or methyl or
R²; R⁴ and R³; R⁵ are each, independently of one another, —CH₂)₂—, —(CH₂)₃—, —C(CH₃)₂—CH₂—CH(CH₃)— or —O(CH₂)₂—,
Y is SO₂—Y¹ or POY²Y³,
Y¹ is —NH—R⁶ or —NR⁶R⁷,
Y² and Y³ are identical and are each methyl, ethyl, —O—R⁶, —NH—R⁶ or —NR⁶R⁷, or Y² and Y³ together form a —(CH₂)₄— bridge, or
Y² is phenyl and
Y³ is —O—R⁶, —NH—R⁶ or —NR⁶R⁷,
R⁶ and R⁷ are each, independently of one another, methyl, ethyl, propyl, butyl, 2,2,2-trifluoroethyl, 2,2-difluoroethyl, 2,2,3,3-tetrafluoropropyl, 1H,1H-heptafluorobutyl, 1H,1H,4H-hexafluorobutyl, cyclohexyl, allyl, benzyl or phenyl or
NR⁶R⁷ is pyrrolidino, piperidino or morpholino,
M is nickel, zinc, copper, cobalt, iron or palladium.

Very particular preference is likewise given to metal complexes of ligands of the formula (I), in particular complexes of the formula (Ib), in which
M is boron, aluminum or cobalt,
An⁻ is iodide, nitrate, tetrafluoroborate, perchlorate, hexafluorophosphate, methanesulfonate, trifluoromethanesulfonate or the anion or one equivalent of an anion of a rhodamine, oxonol or azo metal complex dye
   and the other radicals are as defined above.

Suitable rhodamine dyes are dyes of the formula (C) 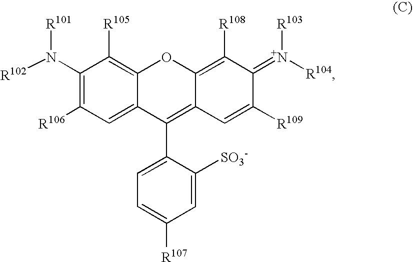
where
R¹⁰¹ and R¹⁰³ are each, independently of one another, hydrogen, methyl or ethyl,
R¹⁰² and R¹⁰⁴ are each, independently of one another, a sulfo- or carboxy-substituted phenyl, naphthyl, benzothiazolyl or benzoxazolyl radical which may also be substituted by chlorine, hydroxy, methyl, methoxy or methylthio,
R¹⁰⁵, R¹⁰⁶, R¹⁰⁸ and R¹⁰⁹ are each, independently of one another, hydrogen, methyl or methoxy or
R¹⁰¹; R¹⁰⁵, R¹⁰²; R¹⁰⁶, R¹⁰³; R¹⁰⁸ and R¹⁰⁴; R¹⁰⁹ are each, independently of one another, —(CH₂)₂—, —(CH₂)₃—, —C(CH₃)₂—CH₂—CH(CH₃)— or —O(CH₂)₂— and
R¹⁰⁷ is hydrogen or sulfo.

Suitable oxonol dyes are dyes of the formula (CI) 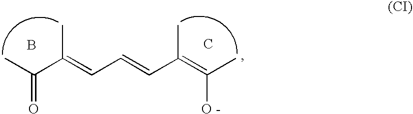
where
the rings B and C are each a five- or six-membered, carbocyclic or heterocyclic ring.

In the formula (CI), B and C are preferably identical.

Preference is given to the ring B together with the two carbon atoms and the oxygen atom being a radical of one of the formulae 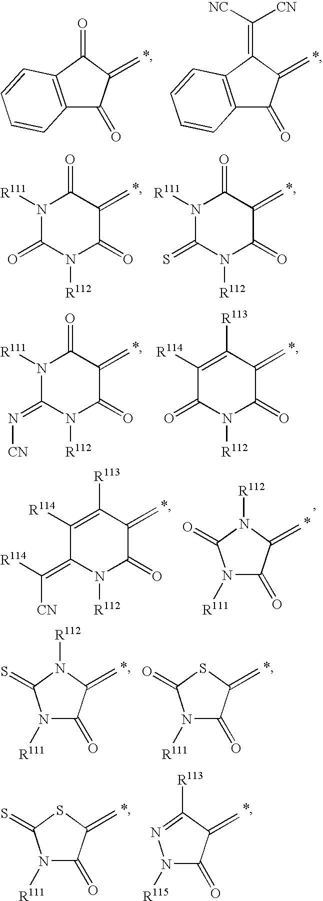
and the ring C together with the two carbon atoms and the oxygen atom being a radical of one of the formulae 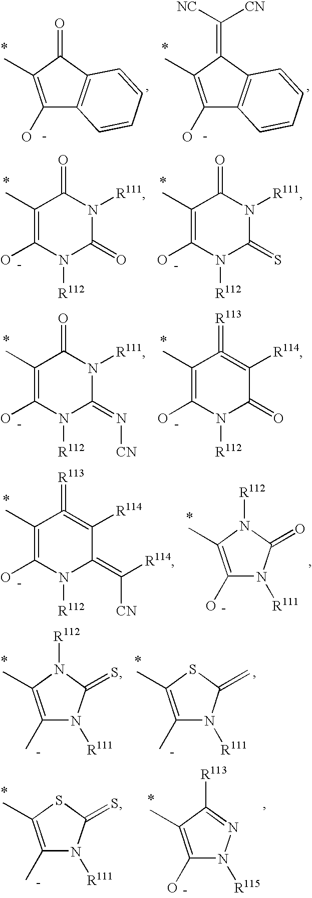
where
R¹¹¹ and R¹¹² are each, independently of one another, hydrogen or methyl,
R¹¹³ is methyl or trifluoromethyl,
R¹¹⁴ is cyano, methoxycarbonyl or ethoxycarbonyl,
R¹¹⁵ is phenyl, chlorophenyl or tolyl.

Suitable azo metal complex dyes are compounds of the formula (CII) 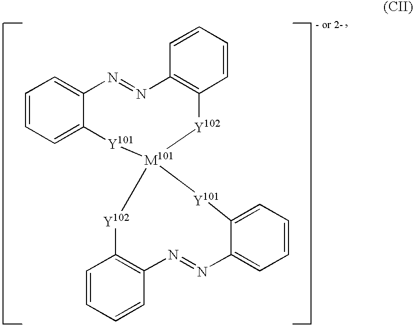
where
Y¹⁰¹ and Y¹⁰² are each, independently of one another, —O— or —COO—,
M¹⁰¹ is a divalent or trivalent metal and the benzene rings may be benzo-fused and/or substituted by nonionic radicals.

Nonionic radicals have been defined above.
M¹⁰¹ is preferably Ni, Co, Cr, Fe, Cu.

Especial preference is given to metal complexes of ligands of the formula (I), in particular complexes of the formula (Ia),

in which

the ring A of the formula (III) 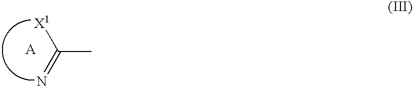
is benzothiazol-2-yl, chlorobenzothiazol-2-yl, methylbenzothiazol-2-yl, methoxybenzothiazol-2-yl or nitrobenzothiazol-2-yl, benzimidazol-2-yl, thiazol-2-yl, phenylthiazol-2-yl, cyanothiazol-2-yl, nitrothiazol-2-yl, 5-fluoro-4-trifluoromethylthiazol-2-yl, 5-phenyl-4-trifluoromethylthiazol-2-yl, 2-methylthio-5-cyano-thiazol-4-yl, imidazol-2-yl, 4,5-diphenylimidazol-2-yl, 4,5-dicyanoimidazol-2-yl, 4,5-bis-methoxycarbonylimidazol-2-yl or 4,5-bis-ethoxycarbonyl-imidazol-2-yl, pyrazol-5-yl, 1,3,4-thiadiazol-2-yl, 5-phenoxy-1,3,4-thiadiazol-2-yl, 5-methylthio-1,3,4-thiadiazol-2-yl, 5-dimethylamino-1,3,4-thiadiazol-2-yl, 5-diethylamnino-1,3,4-thiadiazol-2-yl, 5-di(iso)-propylamino-1,3,4-thiadiazol-2-yl, 5-N-methyl-N-cyanoethylamino-1,3,4-thiadiazol-2-yl, 5-pyrrolidino-1,3,4-thiadiazol-2-yl, 5-phenyl-1,3,4-thiadiazol-2-yl, 5-methyl-1,3,4-thiadiazole, 1,2,4-thiadiazol-5-yl, 3-methylthio-1,2,4-thiadiazol-5-yl, 3-methanesulfonyl-1,2,4-thiadiazol-5-yl, 3-phenyl-1,2,4-thiadiazol-5-yl, 5-methyl-1,2,4-thiadiazol-3-yl, 1,3,4-triazol-2-yl, 2-pyridyl, 2-quinolyl, 2-pyrimidyl, 4-cyano-2-pyrimidyl, 4,6-dicyano-2-pyrimidyl, 1,3,5-triazin-2-yl or 2-pyrazinyl,
in which
   X¹ is O, S, N—R¹ or CH,
R¹ is hydrogen, methyl, ethyl or benzyl,
R² and R³ are each, independently of one another, methyl, ethyl, cyanoethyl, cyclohexyl, benzyl or phenyl or
NR²R³ is pyrrolidino, piperidino or morpholino,
R⁴ is hydrogen, methyl or methoxy,
R⁵ is hydrogen or
R²; R⁴ is —(CH₂)₂— or —(CH₂)₃—,
Y is SO₂—Y¹ or POY²Y³,
Y¹ is —NH—R⁶ or —NR⁶R⁷,
Y² and Y³ are identical and are each —R⁶,
R⁶ and R⁷ are each, independently of one another, methyl, ethyl, 2,2,2-trifluoroethyl, 2,2-difluoroethyl, 2,2,3,3-tetrafluoropropyl, benzyl or phenyl or
NR⁶R⁷ is pyrrolidino, piperidino or morpholino,
M is nickel, zinc, copper or cobalt.

Especial preference is likewise given to metal complexes of ligands of the formula (I), in particular complexes of the formula (Ib),

in which

M is cobalt,
An⁻ is iodide, nitrate, tetrafluoroborate, perchlorate, hexafluorophosphate or the anion of the formula 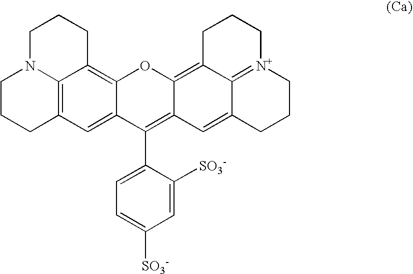
   and the other radicals are as defined above.

The ring A of the formula (III) 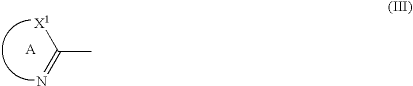
is preferably 4,5-dicyanoimidazol-2-yl, 1-methyl-4,5-dicyanoimidazol-2-yl, 1-ethyl-4,5-dicyanoimidazol-2-yl, 1-benzyl-4,5-dicyanoimidazol-2-yl, 1-(2,2,2-trifluoroethyl)-4,5-dicyanoimidazol-2-yl, 3-phenyl-1,2,4-thiadiazol, 3-pyridyl-1,2,4-thiadiazol, 3-methanesulfonyl-1,2,4-thiadiazole, 5-dimethylamino-1,3,4-thiadiazole, 5-diisopropylamino-1,3,4-thiadiazole, 5-pyrrolidino-1,3,4-thiadiazole, 5-phenyl-1,3,4-thiadiazol-2-yl, 5-methyl-1,3,4-thiadiazole, 2-pyridyl, 2-pyrimidyl, 4-cyano-2-pyrimidyl.

The metal complexes of the invention are sold, in particular, as powders or granular materials or as solutions having a solids content of at least 2% by weight. Preference is given to granular materials, in particular granular materials having a mean particle size of from 50 μm to 10 mm, in particular from 100 to 800 μm. Such granular materials can be produced, for example, by spray drying. The granular materials are in particular, low in dust.

The metal complexes of the invention display a good solubility. They are readily soluble in nonfluorinated alcohols. Such alcohols are, for example, alcohols having from 3 to 6 carbon atoms, preferably propanol, butanol, pentanol, hexanol, diacetone alcohol or mixtures of these alcohols, e.g. propanol/diacetone alcohol, butanol/diacetone alcohol, butanol/hexanol. Preferred mixing ratios for the mixtures listed are, for example, from 80:20 to 99:1, preferably from 90:10 to 98:2.

Preference is likewise given to concentrated solutions. They preferably contain at least 1 percent by weight, preferably at least 2 percent by weight, particularly preferably at least 5 percent by weight, of the metal complexes of the invention, in particular those of the formulae (Ia), (Ib) and (II). As solvent for these solutions, preference is given to using 2,2,3,3-tetrafluoropropanol, propanol, butanol, pentanol, hexanol, diacetone alcohol, dibutyl ether, heptanone or mixtures thereof. Particular preference is given to 2,2,3,3-tetrafluoropropanol. Particular preference is likewise given to butanol. Particular preference is also given to butanol/diacetone alcohol in a mixing ratio of from 90:10 to 98:2.

The invention further provides a process for preparing the novel metal complexes of the formulae (Ia) and (Ib), which is characterized in that a metal salt is reacted with an azo compound of the formula (Ic) 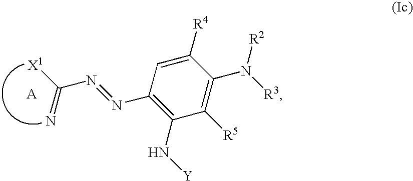
in which
X¹ is O, S, N—R¹ or CH,
A together with X¹ and N forms a five- or six-membered aromatic or pseudoaromatic heterocyclic ring which contains from 1 to 4 heteroatoms and/or can be benzo- or naphtho-fused and/or be substituted by nonionic radicals,
R¹ is hydrogen, substituted or unsubstituted C₁-C₁₂-alkyl, substituted or unsubstituted C₃-C₈-cycloalkyl, substituted or unsubstituted C₂-C₁₂-alkenyl or substituted or unsubstituted C₇-C₁₂-aralkyl,
R² and R³ are each, independently of one another, hydrogen, substituted or unsubstituted C₁-C₁₂-alkyl, substituted or unsubstituted C₃-C₈-cycloalkyl, substituted or unsubstituted C₂-C₁₂-alkenyl, substituted or unsubstituted C₂-C₁₂-alkynyl, substituted or unsubstituted C₇-C₁₂-aralkyl, substituted or unsubstituted C₆-C₁₀-aryl or a five- or six-membered heterocyclic ring or
NR²R³ together with the nitrogen atom is a five- to seven-membered heterocyclic ring which may contain further heteroatoms and/or be substituted by nonionic radicals,
R⁴ and R⁵ are each, independently of one another. hydrogen, halogen, substituted or unsubstituted C₁-C₆-alkyl, substituted or unsubstituted C₁-C₆-alkoxy or substituted or unsubstituted C₁-C₆-alkylthio or
R²; R⁴ and R³; R⁵ are each, independently of one another, a divalent to tetravalent bridge which may contain further heteroatoms and/or be substituted by nonionic radicals,
Y is SO₂—Y¹ or POY²Y³,
Y¹ is —O—R⁶, —NH—R⁶ or NR⁶R⁷,
Y² and Y³ are each, independently of one another, substituted or unsubstituted C₁-C₁₂-alkyl, substituted or unsubstituted C₆-C₁₀-aryl, a substituted or unsubstituted five- or six-membered pseudoaromatic or aromatic heterocyclic radical, —O—R⁶, —NH—R⁶ or NR⁶R⁷, or Y² and Y³ together form a bridge,
R⁶ and R⁷ are each, independently of one another, substituted or unsubstituted C₁-C₁₂-alkyl, substituted or unsubstituted C₃-C₈-cycloalkyl, substituted or unsubstituted C₂-C₁₂-alkenyl, substituted or unsubstituted C₂-C₁₂-alkynyl, substituted or unsubstituted C₇-C₁₂-aralkyl, substituted or unsubstituted C₆-C₁₀-aryl or a five- or six-membered heterocyclic ring or
NR⁶R⁷ together with the nitrogen atom is a five- to seven-membered heterocyclic ring which may contain further heteroatoms and/or be substituted by nonionic radicals.

In this process of the invention, it is also possible to use two or more different azo compounds of the formula (Ic). This then gives a random mixture of metal complexes consisting of complexes containing two identical ligands of the formula (I) and complexes containing two different ligands of the formula (I). These mixtures are likewise subject matter of the invention.

The preparation of metal complexes and the metal complexes themselves are also encompassed analogously when a mixture of azo compounds of the formula Ic is used in their preparation.

The reaction according to the invention is generally carried out in a solvent or solvent mixture, in the presence or absence of basic substances, at from room temperature to the boiling point of the solvent, for example at 20-100° C., preferably 20-50° C. The metal complexes either precipitate directly and can be isolated by filtration or they are precipitated by, for example, addition of water, possibly with prior partial or complete removal of the solvent, and isolated by filtration. It is also possible to carry out the reaction directly in the solvent to give the abovementioned concentrated solutions.

For the purposes of the present invention, metal salts are, for example, the chlorides, bromides, sulfates, hydrogensulfates, phosphates, hydrogenphosphates, dihydrogenphosphates, hydroxides, oxides, carbonates, hydrogencarbonates, carboxylates such as formates, acetates, propionates, benzoates, sulfonates such as methanesulfonates, trifluoromethanesulfonates or benzenesulfonates of the corresponding metals. The term metal salts likewise encompasses metal complexes of ligands other than those of the formula (I), in particular complexes of acetylacetone and ethyl acetoacetate. Examples of suitable metal salts are: nickel acetate, cobalt acetate, copper acetate, nickel chloride, nickel sulfate, cobalt chloride, copper chloride, copper sulfate, nickel hydroxide, nickel oxide, nickel acetylacetonate, cobalt hydroxide, basic copper carbonate, barium chloride, iron sulfate, palladium acetate, palladium chloride and their variants which contain water of crystallization.

Possible basic substances are alkali metal acetates such as sodium acetate, potassium acetate, alkali metal hydrogencarbonates, carbonates or hydroxides, e.g. sodium hydrogencarbonate, potassium carbonate, lithium hydroxide, sodium hydroxide, or amines such as ammonia, dimethylamine, triethylamine, diethanolamine. Such basic substances are particularly advantageous when metal salts of strong acids, e.g. metal chlorides or sulfates, are used.

Suitable solvents include water, alcohols such as methanol, ethanol, propanol, butanol, 2,2,3,3-tetrafluoropropanol, ethers such as dibutyl ether, dioxane or tetrahydrofuran, aprotic solvents such as dimethylformamide, N-methylpyrrolidone, acetonitrile, nitromethane, dimethyl sulfoxide. Preference is given to methanol, ethanol and 2,2,3,3-tetrafluoropropanol.

The salt-like metal complexes of the formula (Ib) can also be prepared by oxidation of metal complexes of the formula (Ia). They can also be prepared by reacting azo dyes of the formula (Ic) with salts of divalent metals in the presence of an oxidizing agent.

Suitable oxidizing agents are, for example, nitric acid, nitrous acid, hydrogen peroxide, Caro's acid, alkali metal peroxodisulfates, alkali metal perborates, air, oxygen. Preference is given to nitric acid and air.

The conditions of the reaction are as indicated above.

The azo compounds of the formula (Ic) required for preparing the metal complexes of the invention are likewise subject matter of the present invention. Some of them are known from EP-A 0 040 171.

The invention therefore also provides azo compounds of the formula (Ic) 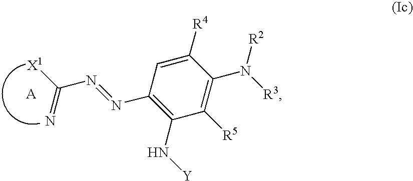
in which
X¹ is O, S, N—R¹ or CH,
A together with X¹ and N forms a five- or six-membered aromatic or pseudoaromatic heterocyclic ring which contains from 1 to 4 heteroatoms and/or can be benzo- or naphtho-fused and/or be substituted by nonionic radicals,
R¹ is hydrogen, substituted or unsubstituted C₁-C₁₂-alkyl, substituted or unsubstituted C₃-C₈-cycloalkyl, substituted or unsubstituted C₂-C₁₂-alkenyl or substituted or unsubstituted C₇-C₁₂-aralkyl,
R² and R³ are each, independently of one another, hydrogen, substituted or unsubstituted C₁-C₁₂-alkyl, substituted or unsubstituted C₃-C₈-cycloalkyl, substituted or unsubstituted C₂-C₁₂-alkenyl, substituted or unsubstituted C₂-C₁₂-alkynyl, substituted or unsubstituted C₇-C₁₂-aralkyl, substituted or unsubstituted C₆-C₁₀-aryl or a five- or six-membered heterocyclic ring or
NR²R³ together with the nitrogen atom is a five- to seven-membered heterocyclic ring which may contain further heteroatoms and/or be substituted by nonionic radicals,
R⁴ and R⁵ are each, independently of one another, hydrogen, halogen, substituted or unsubstituted C₁-C₆-alkyl, substituted or unsubstituted C₁-C₆-alkoxy or substituted or unsubstituted C₁-C₆-alkylthio or
R²; R⁴ and R³; R⁵ are each, independently of one another, a divalent to tetravalent bridge which may contain further heteroatoms and/or be substituted by nonionic radicals,
Y is SO₂—Y¹ or POY²Y³,
Y¹ is —O—R⁶, —NH—R⁶ or NR⁶R⁷,
Y² and Y³ are each, independently of one another, substituted or unsubstituted C₁-C₁₂-alkyl, substituted or unsubstituted C₆-C₁₀-aryl, a substituted or unsubstituted five- or six-membered pseudoaromatic or aromatic heterocyclic radical, —O—R⁶, —NH—R⁶ or NR⁶R⁷, or Y² and Y³ together form a bridge,
R⁶ and R⁷ are each, independently of one another, substituted or unsubstituted C₁-C₁₂-alkyl, substituted or unsubstituted C₃-C₈-cycloalkyl, substituted or unsubstituted C₂-C₁₂-alkenyl, substituted or unsubstituted C₂-C₁₂-alkynyl, substituted or unsubstituted C₇-C₁₂-aralkyl, substituted or unsubstituted C₆-C₁₀-aryl or a five- or six-membered heterocyclic ring or
NR⁶R⁷ together with the nitrogen atom is a five- to seven-membered heterocyclic ring which may contain further heteroatoms and/or be substituted by nonionic radicals.

Particular preference is given to azo compounds of the formula (Ic)

in which

the ring A of the formula (III) 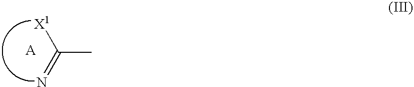
is benzothiazol-2-yl which may bear up to three identical or different radicals selected from the group consisting of chloro, methyl, methoxy, ethoxy, cyano and nitro as substituents, benzimidazol-2-yl which may bear up to three identical or different radicals selected from the group consisting of chloro, methyl, methoxy, ethoxy, cyano and nitro as substituents, thiazol-2-yl which may bear up to two identical or different radicals selected from the group consisting of chloro, fluoro, methyl, trifluoromethyl, methoxy, phenyl, cyano, nitro, methoxycarbonyl, methanesulfonyl, formyl and the divalent radical of the formula —(CH₂)₄— as substituents, thiazol-4-yl which may bear up to two identical or different radicals selected from the group consisting of chloro, fluoro, methoxy, methylthio, phenyl and cyano as substituents, imidazol-2-yl which may bear up to two identical or different radicals selected from the group consisting of fluoro, chloro, methyl, trifluoromethyl, methoxy, phenyl, cyano, nitro, CH₃O—(C═NH)—, methoxycarbonyl and ethoxycarbonyl as substituents, pyrazol-5-yl which may bear up to two identical or different radicals selected from the group consisting of chloro, methyl, methoxy, phenyl, cyano and nitro as substituents, 1,3,4-thiadiazol-2-yl which may bear a chloro, bromo, methoxy, phenoxy, methanesulfonyl, methylthio, ethylthio, dimethylamino, diethylamino, di(iso)propylamino, N-methyl-N-cyanoethylamino, N,N-biscyanoethylamino, N-methyl-N-hydroxyethylamino, N-methyl-N-benzylamino, N-methyl-N-phenylamino, anilino, pyrrolidino, piperidino or morpholino substituent, 1,2,4-thiadiazol-5-yl which may bear a chloro, methyl, methoxy, phenoxy, methylthio, methanesulfonyl, phenyl, dimethylamino or anilino substituent, 1,2,4-thiadiazol-3-yl which may bear a methyl or phenyl substituent, 1,3,4-triazol-2-yl which may bear a methyl or phenyl substituent, 2-pyridyl which may bear chloro, methyl, methoxy, cyano, methoxycarbonyl or nitro substituents, 2-quinolyl which may bear chloro, methyl, methoxy, cyano, methoxycarbonyl or nitro substituents, 2-pyrimidyl which may bear up to three identical or different radicals selected from the group consisting of chloro, methyl, methoxy, cyano, methoxycarbonyl and nitro as substituents, 1,3,5-triazin-2-yl or 2-pyrazinyl,
   where
   X¹ is O, S, N—R¹ or CH,
R¹ is hydrogen, methyl, ethyl, propyl, butyl, allyl, benzyl, phenethyl or phenylpropyl,
R² and R³ are each, independently of one another, hydrogen, methyl, ethyl, propyl, butyl, hydroxyethyl, cyanoethyl, cyclopentyl, cyclohexyl, allyl, benzyl, phenethyl, phenylpropyl, phenyl, tolyl, chlorophenyl or anisyl or
NR²R³ is pyrrolidino, piperidino or morpholino,
R⁴ is hydrogen, chlorine, methyl, methoxy or methylthio,
R⁵ is hydrogen or methyl or
R²; R⁴ and R³; R⁵ are each, independently of one another, —(CH₂)₂—, —(CH₂)₃—, —C(CH₃)₂—CH₂—CH(CH₃)— or —O(CH₂)₂—,
Y is SO₂—Y¹ or POY²Y³,
Y¹ is —NH—R⁶ or —NR⁶R⁷,
Y² and Y³ are identical and are each methyl, ethyl, —O—R⁶, —NH—R⁶ or —NR⁶R⁷, or
Y² and Y³ together form a —(CH₂)₄— bridge, or
Y² is phenyl and
Y³ is —O—R⁶, —NH—R⁶ or —NR⁶R⁷,
R⁶ and R⁷ are each, independently of one another, methyl, ethyl, propyl, butyl, 2,2,2-trifluoroethyl, 2,2-difluoroethyl, 2,2,3,3-tetrafluoropropyl, 1H,1H-heptafluorobutyl, 1H,1H,4H-hexafluorobutyl, cyclohexyl, allyl, benzyl or phenyl or
NR⁶R⁷ is pyrrolidino, piperidino or morpholino.

The invention likewise provides a process for preparing the novel azo compounds of the formula (Ic), which is characterized in that an aminoheterocycle of the formula (IV) 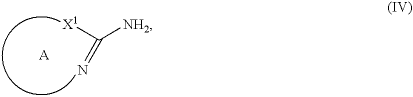
where
X¹ is O, S, N—R¹— or CH,
A together with X¹ and N forms a five- or six-membered aromatic or pseudoaromatic heterocyclic ring which contains from 1 to 4 heteroatoms and/or may be benzo- or naphtho-fused and/or be substituted by nonionic radicals,
R¹ is hydrogen, substituted or unsubstituted C₁-C₁₂-alkyl, substituted or unsubstituted C₃-C₈-cycloalkyl, substituted or unsubstituted C₂-C₁₂-alkenyl or substituted or unsubstituted C₇-C₁₂-aralkyl,
   is diazotized or nitrosated and coupled with a coupling component of the formula (V) 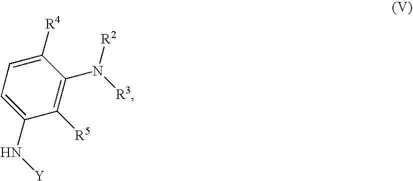
   where
R² and R³ are each, independently of one another, hydrogen, substituted or unsubstituted C₁-C₁₂-alkyl, substituted or unsubstituted C₃-C₈-cycloalkyl, substituted or unsubstituted C₂-C₁₂-alkenyl, substituted or unsubstituted C₂-C₁₂-alkynyl, substituted or unsubstituted C₇-C₁₂-aralkyl, substituted or unsubstituted C₆-C₁₀-aryl or a five- or six-membered heterocyclic ring or
NR²R³ together with the nitrogen atom is a five- to seven-membered heterocyclic ring which may contain further heteroatoms and/or be substituted by nonionic radicals,
R⁴ and R⁵ are each, independently of one another, hydrogen, halogen, substituted or unsubstituted C₁-C₆-alkyl, substituted or unsubstituted C₁-C₆-alkoxy or substituted or unsubstituted C₁-C₆-alkylthio or
R²; R⁴ and R³; R⁵ are each, independently of one another, a divalent to tetravalent bridge which may contain further heteroatoms and/or be substituted by nonionic radicals,
Y is SO₂—Y¹ or POY²Y³,
Y¹ is —O—R⁶, —NH—R⁶ or NR⁶R⁷,
Y² and Y³ are each, independently of one another, substituted or unsubstituted C₁-C₁₂-alkyl, substituted or unsubstituted C₆-C₁₀-aryl, a substituted or unsubstituted five- or six-membered pseudoaromatic or aromatic heterocyclic radical, —O—R⁶, —NH—R⁶ or NR⁶R⁷, or Y² and Y³ together form a bridge,
R⁶ and R⁷ are each, independently of one another, substituted or unsubstituted C₁-C₁₂-alkyl, substituted or unsubstituted C₃-C₈-cycloalkyl, substituted or unsubstituted C₂-C₁₂-alkenyl, substituted or unsubstituted C₂-C₁₂-alkynyl, substituted or unsubstituted C₇-C₁₂-aralkyl, substituted or unsubstituted C₆-C₁₀-aryl or a five- or six-membered heterocyclic ring or
NR⁶R⁷ together with the nitrogen atom is a five- to seven-membered heterocyclic ring which may contain further heteroatoms and/or be substituted by nonionic radicals.

The invention also provides a process for preparing the novel azo compounds of the formula (Ic), characterized in that
an aminoheterocycle of the formula (IV) 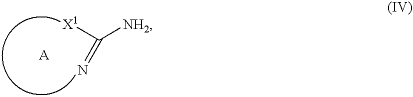
in which
X¹ is N—H,
A together with X¹ and N forms a five- or six-membered aromatic or pseudoaromatic heterocyclic ring which contains from 1 to 4 heteroatoms and/or may be benzo- or naphtho-fused and/or be substituted by nonionic radicals,
   is diazotized or nitrosated and coupled with a coupling component of the formula (V) 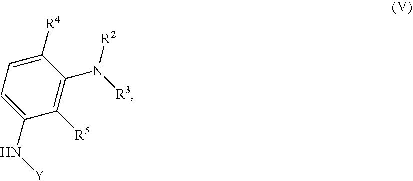
   where
R² and R³ are each, independently of one another, hydrogen, substituted or unsubstituted C₁-C₁₂-alkyl, substituted or unsubstituted C₃-C₈-cycloalkyl, substituted or unsubstituted C₂-C₁₂-alkenyl, substituted or unsubstituted C₂-C₁₂-alkynyl, substituted or unsubstituted C₇-C₁₂-aralkyl, substituted or unsubstituted C₆-C₁₀-aryl or a five- or six-membered heterocyclic ring or
NR²R³ together with the nitrogen atom is a five- to seven-membered heterocyclic ring which may contain further heteroatoms and/or be substituted by nonionic radicals,
R⁴ and R⁵ are each, independently of one another, hydrogen, halogen, substituted or unsubstituted C₁-C₆-alkyl, substituted or unsubstituted C₁-C₆-alkoxy or substituted or unsubstituted C₁-C₆-alkylthio or
R²; R⁴ and R³; R⁵ are each, independently of one another, a divalent to tetravalent bridge which may contain further heteroatoms and/or be substituted by nonionic radicals,
Y is SO₂—Y¹ or POY²Y³,
Y¹ is —O—R⁶, —NH—R⁶ or NR⁶R⁷,
Y² and Y³ are each, independently of one another, substituted or unsubstituted C₁-C₁₂-alkyl, substituted or unsubstituted C₆-C₁₀-aryl, a substituted or unsubstituted five- or six-membered pseudoaromatic or aromatic heterocyclic radical, —O—R⁶, —NH—R⁶ or NR⁶R⁷, or Y² and Y³ together form a bridge,
R⁶ and R⁷ are each, independently of one another, substituted or unsubstituted C₁-C₁₂-alkyl, substituted or unsubstituted C₃-C₈-cycloalkyl, substituted or unsubstituted C₂-C₁₂-alkenyl, substituted or unsubstituted C₂-C₁₂-alkynyl, substituted or unsubstituted C₇-C₁₂-aralkyl, substituted or unsubstituted C₆-C₁₀-aryl or a five- or six-membered heterocyclic ring or
NR⁶R⁷ together with the nitrogen atom is a five- to seven-membered heterocyclic ring which may contain further heteroatoms and/or be substituted by nonionic radicals,
   and the product is subsequently reacted with an alkylating agent of the formula
   R¹-Z (VI),
   where
R¹ is substituted or unsubstituted C₁-C₁₂-alkyl, substituted or unsubstituted C₃-C₈-cycloalkyl, substituted or unsubstituted C₂-C₁₂-alkenyl or substituted or unsubstituted C₇-C₁₂-aralkyl,
   and
Z is a leaving group,
   preferably in the presence of a basic substance.

R¹-Z is, for example, an alkyl or aralkyl chloride, bromide, iodide, methanesulfonate, trifluoromethanesulfonate, benzenesulfonate or toluenesulfonate or an alkyl or aralkyl sulfate. Examples are methyl iodide, benzyl bromide, dimethyl sulfate, ethyl toluenesulfonate.

Suitable basic substances are the basic substances mentioned above.

Diazotizations, nitrosations and couplings are known per se from the literature, e.g. from Chem. Ber. 1958, 91, 1025; Chem. Ber. 1961, 94, 2043; U.S. Pat. No. 5,208,325. The procedures described there can be employed in an analogous manner.

The aminoheterocycles of the formula IV to be used in the process of the invention are known, e.g. from J. Polym. Sci.: Part A: Polym. Chem. 1993, 31, 351, Chem. Ber. 1954, 87, 68; Chem. Ber. 1956, 89, 1956, 2742; DE-A 2 811 258.

The invention further provides the coupling component of the formula (V) 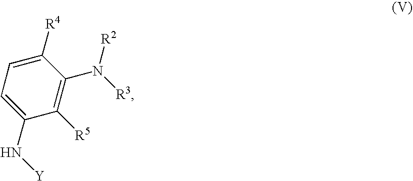
where
R² and R³ are each, independently of one another, hydrogen, substituted or unsubstituted C₁-C₁₂-alkyl, substituted or unsubstituted C₃-C₈-cycloalkyl, substituted or unsubstituted C₂-C₁₂-alkenyl, substituted or unsubstituted C₂-C₁₂-alkynyl, substituted or unsubstituted C₇-C₁₂-aralkyl, substituted or unsubstituted C₆-C₁₀-aryl or a five- or six-membered heterocyclic ring or
NR²R³ together with the nitrogen atom is a five- to seven-membered heterocyclic ring which may contain further heteroatoms and/or be substituted by nonionic radicals,
R⁴ and R⁵ are each, independently of one another, hydrogen, halogen, substituted or unsubstituted C₁-C₆-alkyl, substituted or unsubstituted C₁-C₆-alkoxy or substituted or unsubstituted C₁-C₆-alkylthio or
R²; R⁴ and R³; R⁵ are each, independently of one another, a divalent to tetravalent bridge which may contain further heteroatoms and/or be substituted by nonionic radicals,
Y is SO₂—Y¹ or POY²Y³,
Y¹ is —O—R⁶, —NH—R⁶ or NR⁶R⁷,
Y² and Y³ are each, independently of one another, substituted or unsubstituted C₁-C₁₂-alkyl, substituted or unsubstituted C₆-C₁₀-aryl, a substituted or unsubstituted five- or six-membered pseudoaromatic or aromatic heterocyclic radical, —O—R⁶, —NH—R⁶ or NR⁶R⁷, or Y² and Y³ together form a bridge,
R⁶ and R⁷ are each, independently of one another, substituted or unsubstituted C₁-C₁₂-alkyl, substituted or unsubstituted C₃-C₈-cycloalkyl, substituted or unsubstituted C₂-C₁₂-alkenyl, substituted or unsubstituted C₂-C₁₂-alkynyl, substituted or unsubstituted C₇-C₁₂-aralkyl, substituted or unsubstituted C₆-C₁₀-aryl or a five- or six-membered heterocyclic ring or
NR⁶R⁷ together with the nitrogen atom is a five- to seven-membered heterocyclic ring which may contain further heteroatoms and/or be substituted by nonionic radicals.

Preference is given to coupling components of the formula (V)

in which

R⁶ is a fluoro-substituted ethyl, propyl or butyl radical, in particular 2,2,2-trifluoroethyl, 2,2-difluoroethyl, 2,2,3,3-tetrafluoropropyl, 1H,1H-heptafluorobutyl, 1H,1H,4H-hexafluorobutyl und
R⁷ is methyl, ethyl or a fluoro-substituted ethyl, propyl or butyl radical, in particular 2,2,2-trifluoroethyl, 2,2-difluoroethyl, 2,2,3,3-tetrafluoropropyl, 1H,1H-heptafluorobutyl, 1H,1H,4H-hexafluorobutyl.

The invention likewise provides a process for preparing coupling components of the formula V, which is characterized in that
an m-phenylenediamine of the formula (VI) 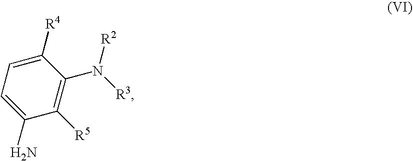
where
R² and R³ are each, independently of one another, hydrogen, substituted or unsubstituted C₁-C₁₂-alkyl, substituted or unsubstituted C₃-C₈-cycloalkyl, substituted or unsubstituted C₂-C₁₂-alkenyl, substituted or unsubstituted C₂-C₁₂-alkynyl, substituted or unsubstituted C₇-C₁₂-aralkyl, substituted or unsubstituted C₆-C₁₀-aryl or a five- or six-membered heterocyclic ring or
NR²R³ together with the nitrogen atom is a five- to seven-membered heterocyclic ring which may contain further heteroatoms and/or be substituted by nonionic radicals,
R⁴ and R⁵ are each, independently of one another, hydrogen, halogen, substituted or unsubstituted C₁-C₆-alkyl, substituted or unsubstituted C₁-C₆-alkoxy or substituted or unsubstituted C₁-C₆-alkylthio or
R²; R⁴ and R³; R⁵ are each, independently of one another, a divalent to tetravalent bridge which may contain further heteroatoms and/or be substituted by nonionic radicals,
   is reacted with a sulfuric acid or phosphoric acid derivative of the formula
   Z¹-SO₂—Y¹ (VII) or
   Z¹-POY²Y³ (VIII)
   where
Z¹ is chlorine or bromine,
Y¹ is —O—R⁶, —NH—R⁶ or NR⁶R⁷,
Y² and Y³ are each, independently of one another, substituted or unsubstituted C₁-C₁₂-alkyl, substituted or unsubstituted C₆-C₁₀-aryl, a substituted or unsubstituted five- or six-membered pseudoaromatic or aromatic heterocyclic radical, —O—R⁶, —NH—R⁶ or NR⁶R⁷, or Y² and Y³ together form a bridge,
R⁶ and R⁷ are each, independently of one another, substituted or unsubstituted C₁-C₁₂-alkyl, substituted or unsubstituted C₃-C₈-cycloalkyl, substituted or unsubstituted C₂-C₁₂-alkenyl, substituted or unsubstituted C₂-C₁₂-alkynyl, substituted or unsubstituted C₇-C₁₂-aralkyl, substituted or unsubstituted C₆-C₁₀-aryl or a five- or six-membered heterocyclic ring or
NR⁶R⁷ together with the nitrogen atom is a five- to seven-membered heterocyclic ring which may contain further heteroatoms and/or be substituted by nonionic radicals.

The invention likewise provides a process for preparing coupling components of the formula V in which Y is POY²Y³, which is characterized in that
an m-phenylenediamine of the formula (VI) 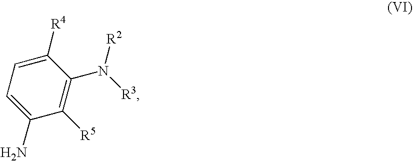
where
R² and R³ are each, independently of one another, hydrogen, substituted or unsubstituted C₁-C₁₂-alkyl, substituted or unsubstituted C₃-C₈-cycloalkyl, substituted or unsubstituted C₂-C₁₂-alkenyl, substituted or unsubstituted C₂-C₁₂-alkynyl, substituted or unsubstituted C₇-C₁₂-aralkyl, substituted or unsubstituted C₆-C₁₀-aryl or a five- or six-membered heterocyclic ring or
NR²R³ together with the nitrogen atom is a five- to seven-membered heterocyclic ring which may contain further heteroatoms and/or be substituted by nonionic radicals,
R⁴ and R⁵ are each, independently of one another, hydrogen, halogen, substituted or unsubstituted C₁-C₆-alkyl, substituted or unsubstituted C₁-C₆-alkoxy or substituted or unsubstituted C₁-C₆-alkylthio or
R²; R⁴ and R³; R⁵ are each, independently of one another, a divalent to tetravalent bridge which may contain further heteroatoms and/or be substituted by nonionic radicals,
   is reacted with a phosphinic acid derivative of the formula
   HPOY²Y³ (IX) or
   P(OH)Y²Y³ (X),
   where
Y² and Y³ are each, independently of one another, —O—R⁶, —NH—R⁶ or NR⁶R⁷,
R⁶ and R⁷ are each, independently of one another, substituted or unsubstituted C₁-C₁₂-alkyl, substituted or unsubstituted C₃-C₈-cycloalkyl, substituted or unsubstituted C₂-C₁₂-alkenyl, substituted or unsubstituted C₂-C₁₂-alkynyl, substituted or unsubstituted C₇-C₁₂-aralkyl, substituted or unsubstituted C₆-C₁₀-aryl or a five- or six-membered heterocyclic ring or
NR⁶R⁷ together with the nitrogen atom is a five- to seven-membered heterocyclic ring which may contain further heteroatoms and/or be substituted by nonionic radicals,
   in the presence of CCl₄ or CBrCl₃.

The invention likewise provides a process for preparing coupling components of the formula V in which Y is SO₂Y¹, which is characterized in that
an m-phenylenediamine of the formula (VI) 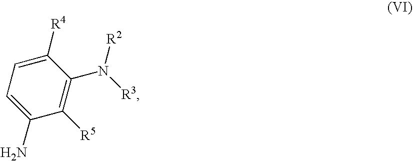
where
R² and R³ are each, independently of one another, hydrogen, substituted or unsubstituted C₁-C₁₂-alkyl, substituted or unsubstituted C₃-C₈-cycloalkyl, substituted or unsubstituted C₂-C₁₂-alkenyl, substituted or unsubstituted C₂-C₁₂-alkynyl, substituted or unsubstituted C₇-C₁₂-aralkyl, substituted or unsubstituted C₆-C₁₀-aryl or a five- or six-membered heterocyclic ring or
NR²R³ together with the nitrogen atom is a five- to seven-membered heterocyclic ring which may contain further heteroatoms and/or be substituted by nonionic radicals,
R⁴ and R⁵ are each, independently of one another, hydrogen, halogen, substituted or unsubstituted C₁-C₆-alkyl, substituted or unsubstituted C₁-C₆-alkoxy or substituted or unsubstituted C₁-C₆-alkylthio or
R²; R⁴ and R³; R⁵ are each, independently of one another, a divalent to tetravalent bridge which may contain further heteroatoms and/or be substituted by nonionic radicals,
   is reacted with chlorosulfonic acid and subsequently with phosphorus pentachloride and this intermediate of the formula 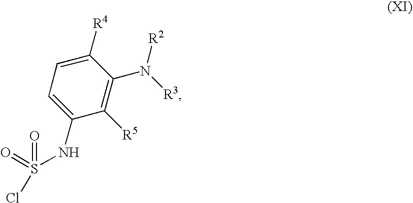
   where R² to R⁵ are as defined above,
   is reacted with an alcohol, phenol or amine of the formula
   HOR⁶ (XII),
   H₂NR⁶ (XIII) or
   HNR⁶R⁷ (XIV),
   where
R⁶ and R⁷ are each, independently of one another, substituted or unsubstituted C₁-C₁₂-alkyl, substituted or unsubstituted C₃-C₈-cycloalkyl, substituted or unsubstituted C₂-C₁₂-alkenyl, substituted or unsubstituted C₂-C₁₂-alkynyl, substituted or unsubstituted C₇-C₁₂-aralkyl, substituted or unsubstituted C₆-C₁₀-aryl or a five- or six-membered heterocyclic ring or
NR⁶R⁷ together with the nitrogen atom is a five- to seven-membered heterocyclic ring which may contain further heteroatoms and/or be substituted by nonionic radicals.

Preference is given to R³ and R⁴≠H for the reaction.

These reactions can be carried out in the presence of a base, for example a tertiary amine or sodium or potassium hydroxide, hydrogencarbonate or carbonate.

This gives the coupling component of the formula (V) in free form or as HCl or HBr salt.

Suitable solvents are 1,2-dichloroethane, carbon tetrachloride, toluene and also alcohols such as methanol or ethanol and water.

Some coupling components of the formula (V) and methods of preparing them are known from J. Chem. Soc. 1949, 2921; Dokl. Akad. Nauk SSSR, 96 (1954) 991; Phosphorus and Sulfur 1983, 155.

Some sulfuric acid, phosphoric acid and phosphinic acid derivatives of the formulae (VII), (VIII), (IX) and (X) are known or they can be prepared in an analogous fashion: J. Fluorine Chem. 113 (2002) 65; J. Chem. Soc. 1949, 2921; J. Org. Chem. 41 (1976) 4028; Synthesis 1983, 63.

The preparation of sulfamic acid chlorides of the formula (XI) can be carried out by methods analogous to those described in J. Org. Chem. 41 (1976) 4028 or Chem. Ber. 120 (1987) 1191.

The invention further provides for the use of the metal complexes of the invention as light-absorbent compounds in the information layer of write-once optical data carriers.

In this use, the optical data carrier is preferably written on and read by means of blue laser light, in particular laser light having a wavelength in the range 360-460 nm.

Preference is likewise given to the optical data carrier being written on and read by means of red laser light, in particular laser light having a wavelength in the range 600-700 nm, in this use.

The invention further provides for the use of metal complexes of azo ligands as light-absorbent compounds in the information layer of write-once optical data carriers which can be written on and read by means of blue laser light, in particular laser light having a wavelength in the range 360-460 nm.

The invention further provides an optical data carrier comprising a preferably transparent substrate which may, if desired, have previously been coated with one or more reflection layers and to whose surface a light-writable information layer, if desired one or more reflection layers and if desired a protective layer or a further substrate or a covering layer have been applied, which can be written on and read by means of blue light, preferably light having a wavelength in the range 360-460 nm, in particular from 390 to 420 nm, very particularly preferably from 400 to 410 nm, or red light, preferably light having a wavelength in the range 600-700 nm, preferably from 620 to 680 nm, very particularly preferably from 630 to 660 nm, preferably laser light, where the information layer comprises a light-absorbent compound and, if desired, a binder, characterized in that at least one metal complex according to the invention is used as light-absorbent compound.

The light-absorbent compound should preferably be able to be changed thermally. The thermal change preferably occurs at a temperature of <600° C., particularly preferably at a temperature of <400° C., very particularly preferably at a temperature of <300° C., in particular <200° C. Such a change may be, for example, a decomposition or chemical change of the chromophoric center of the light-absorbent compound.

The preferred embodiments of the light-absorbent compounds in the optical data store of the invention correspond to the preferred embodiments of the metal complex of the invention.

In a preferred embodiment, the light-absorbent compounds used are compounds of the formula (Ia) or (Ib),

where

X¹ is O, S, N—R¹ or CH,
A together with X¹ and N forms a five- or six-membered aromatic or pseudoaromatic heterocyclic ring which contains from 1 to 4 heteroatoms and/or can be benzo- or naphtho-fused and/or be substituted by nonionic radicals,
R¹ is hydrogen, substituted or unsubstituted C₁-C₁₂-alkyl, substituted or unsubstituted C₃-C₈-cycloalkyl, substituted or unsubstituted C₂-C₁₂-alkenyl or substituted or unsubstituted C₇-C₁₂-aralkyl,
R² and R³ are each, independently of one another, hydrogen, substituted or unsubstituted C₁-C₁₂-alkyl, substituted or unsubstituted C₃-C₈-cycloalkyl, substituted or unsubstituted C₂-C₁₂-alkenyl, substituted or unsubstituted C₂-C₁₂-alkynyl, substituted or unsubstituted C₇-C₁₂-aralkyl, substituted or unsubstituted C₆-C₁₀-aryl or a five- or six-membered heterocyclic ring or
NR²R³ together with the nitrogen atom is a five- to seven-membered heterocyclic ring which may contain further heteroatoms and/or be substituted by nonionic radicals,
R⁴ and R⁵ are each, independently of one another, hydrogen, halogen, substituted or unsubstituted C₁-C₆-alkyl, substituted or unsubstituted C₁-C₆-alkoxy or substituted or unsubstituted C₁-C₆-alkylthio or
R²; R⁴ and R³; R⁵ are each, independently of one another, a divalent to tetravalent bridge which may contain further heteroatoms and/or be substituted by nonionic radicals,
Y is SO₂—Y¹ or POY²Y³,
Y¹ is —O—R⁶, —NH—R⁶ or NR⁶R⁷,
Y² and Y³ are each, independently of one another, substituted or unsubstituted C₁-C₁₂-alkyl, substituted or unsubstituted C₆-C₁₀-aryl, a substituted or unsubstituted five- or six-membered pseudoaromatic or aromatic heterocyclic radical, —O—R⁶, —NH—R⁶ or NR⁶R⁷, or Y² and Y³ together form a bridge,
R⁶ and R⁷ are each, independently of one another, substituted or unsubstituted C₁-C₁₂-alkyl, substituted or unsubstituted C₃-C₈-cycloalkyl, substituted or unsubstituted C₂-C₁₂-alkenyl, substituted or unsubstituted C₂-C₁₂-alkynyl, substituted or unsubstituted C₇-C₁₂-aralkyl, substituted or unsubstituted C₆-C₁₀-aryl or a five- or six-membered heterocyclic ring or
NR⁶R⁷ together with the nitrogen atom is a five- to seven-membered heterocyclic ring which may contain further heteroatoms and/or be substituted by nonionic radicals,
M is a metal and
An⁻ is an anion.

In a particularly preferred embodiment, the light-absorbent compounds used are compounds of the formula (Ia)

in which

the ring A of the formula (III) 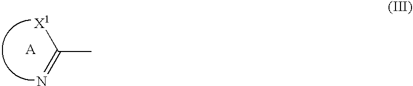
is benzothiazol-2-yl which may bear up to three identical or different radicals selected from the group consisting of chloro, methyl, methoxy, ethoxy, cyano and nitro as substituents, benzimidazol-2-yl which may bear up to three identical or different radicals selected from the group consisting of chloro, methyl, methoxy, ethoxy, cyano and nitro as substituents, thiazol-2-yl which may bear up to two identical or different radicals selected from the group consisting of chloro, fluoro, methyl, trifluoromethyl, methoxy, phenyl, cyano, nitro, methoxycarbonyl, methanesulfonyl, formyl and the divalent radical of the formula —(CH₂)₄— as substituents, thiazol-4-yl which may bear up to two identical or different radicals selected from the group consisting of chloro, fluoro, methoxy, methylthio, phenyl and cyano as substituents, imidazol-2-yl which may bear up to two identical or different radicals selected from the group consisting of fluoro, chloro, methyl, trifluoromethyl, methoxy, phenyl, cyano, nitro, CH₃O—(C═NH)—, methoxycarbonyl and ethoxycarbonyl as substituents, pyrazol-5-yl which may bear up to two identical or different radicals selected from the group consisting of chloro, methyl, methoxy, phenyl, cyano and nitro as substituents, 1,3,4-thiadiazol-2-yl which may bear a chloro, bromo, methoxy, phenoxy, methanesulfonyl, methylthio, ethylthio, dimethylamino, diethylamino, di(iso)propylamino, N-methyl-N-cyanoethylamino, N,N-biscyanoethylamino, N-methyl-N-hydroxyethylamino, N-methyl-N-benzylamino, N-methyl-N-phenylamino, anilino, pyrrolidino, piperidino or morpholino substituent, 1,2,4-thiadiazol-3-yl which may bear a methyl or phenyl substituent, 1,2,4-thiadiazol-5-yl which may bear a chloro, methyl, methoxy, phenoxy, methylthio, methanesulfonyl, phenyl, dimethylamino or anilino substituent, 1,3,4-triazol-2-yl which may bear a methyl or phenyl substituent, 2-pyridyl which may bear chloro, methyl, methoxy, cyano, methoxycarbonyl or nitro substituents, 2-quinolyl which may bear chloro, methyl, methoxy, cyano, methoxycarbonyl or nitro substituents, 2-pyrimidyl which may bear up to three identical or different radicals selected from the group consisting of chloro, methyl, methoxy, cyano, methoxycarbonyl and nitro as substituents, 1,3,5-triazin-2-yl or 2-pyrazinyl,
where
   X¹ is O, S, N—R¹ or CH,
R¹ is hydrogen, methyl, ethyl, propyl, butyl, allyl, benzyl, phenethyl or phenylpropyl,
R² and R³ are each, independently of one another, hydrogen, methyl, ethyl, propyl, butyl, hydroxyethyl, cyanoethyl, cyclopentyl, cyclohexyl, allyl, benzyl, phenethyl, phenylpropyl, phenyl, tolyl, chlorophenyl or anisyl or
NR²R³ is pyrrolidino, piperidino or morpholino,
R⁴ is hydrogen, chlorine, methyl, methoxy or methylthio,
R⁵ is hydrogen or methyl or
R²; R⁴ and R³; R⁵ are each, independently of one another, —(CH₂)₂—, —(CH₂)₃—, —C(CH₃)₂—CH₂—CH(CH₃)— or —O(CH₂)₂—,
Y is SO₂—Y¹ or POY²Y³,
Y¹ is —NH—R⁶ or —NR⁶R⁷,
Y² and Y³ are identical and are each methyl, ethyl, —O—R⁶, —NH—R⁶ or —NR⁶R⁷, or Y² and Y³ together form a —(CH₂)₄— bridge, or
Y² is phenyl and
Y³ is —O—R⁶, —NH—R⁶ or —NR⁶R⁷,
R⁶ and R⁷ are each, independently of one another, methyl, ethyl, propyl, butyl, 2,2,2-trifluoroethyl, 2,2-difluoroethyl, 2,2,3,3-tetrafluoropropyl, 1H,1H-heptafluorobutyl, 1H,1H,4H-hexafluorobutyl, cyclohexyl, allyl, benzyl or phenyl or
NR⁶R⁷ is pyrrolidino, piperidino or morpholino,
M is nickel, zinc, copper, cobalt, iron or palladium.

In a likewise particularly preferred embodiment, the light-absorbent compounds used are compounds of the formula (Ib)

in which

the ring A of the formula (III) 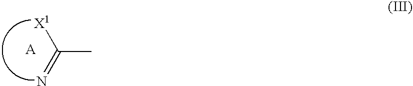
is benzothiazol-2-yl which may bear up to three identical or different radicals selected from the group consisting of chloro, methyl, methoxy, ethoxy, cyano and nitro as substituents, benzimidazol-2-yl which may bear up to three identical or different radicals selected from the group consisting of chloro, methyl, methoxy, ethoxy, cyano and nitro as substituents, thiazol-2-yl which may bear up to two identical or different radicals selected from the group consisting of chloro, fluoro, methyl, trifluoromethyl, methoxy, phenyl, cyano, nitro, methoxycarbonyl, methanesulfonyl, formyl and the divalent radical of the formula —(CH₂)₄— as substituents, thiazol-4-yl which may bear up to two identical or different radicals selected from the group consisting of chloro, fluoro, methoxy, methylthio, phenyl and cyano as substituents, imidazol-2-yl which may bear up to two identical or different radicals selected from the group consisting of fluoro. chloro, methyl, trifluoromethyl, methoxy, phenyl, cyano, nitro, CH₃O—(C═NH)—, methoxycarbonyl and ethoxycarbonyl as substituents, pyrazol-5-yl which may bear up to two identical or different radicals selected from the group consisting of chloro, methyl, methoxy, phenyl, cyano and nitro as substituents, 1,3,4-thiadiazol-2-yl which may bear a chloro, bromo, methoxy, phenoxy, methanesulfonyl, methylthio, ethylthio, dimethylamino, diethylamino, di(iso)propylamino, N-methyl-N-cyanoethylamino, N,N-biscyanoethylamino, N-methyl-N-hydroxyethylamino, N-methyl-N-benzylamino, N-methyl-N-phenylamino, anilino, pyrrolidino, piperidino or morpholino substituent, 1,2,4-thiadiazol-3-yl which may bear a methyl or phenyl substituent, 1,2,4-thiadiazol-5-yl which may bear a chloro, methyl, methoxy, phenoxy, methylthio, methanesulfonyl, phenyl, dimethylamino or anilino substituent, 1,3,4-triazol-2-yl which may bear a methyl or phenyl substituent, 2-pyridyl which may bear chloro, methyl, methoxy, cyano, methoxycarbonyl or nitro substituents, 2-quinolyl which may bear chloro, methyl, methoxy, cyano, methoxycarbonyl or nitro substituents, 2-pyrimidyl which may bear up to three identical or different radicals selected from the group consisting of chloro, methyl, methoxy, cyano, methoxycarbonyl and nitro as substituents, 1,3,5-triazin-2-yl or 2-pyrazinyl,
   where
   X¹ is O, S, N—R¹ or CH,
R¹ is hydrogen, methyl, ethyl, propyl, butyl, allyl, benzyl, phenethyl or phenylpropyl,
R² and R³ are each, independently of one another, hydrogen, methyl, ethyl, propyl, butyl, hydroxyethyl, cyanoethyl, cyclopentyl, cyclohexyl, allyl, benzyl, phenethyl, phenylpropyl, phenyl, tolyl, chlorphenyl or anisyl or
NR²R³ is pyrrolidino, piperidino or morpholino,
R⁴ is hydrogen, chlorine, methyl, methoxy or methylthio,
R⁵ is hydrogen or methyl or
R²; R⁴ and R³; R⁵ are each, independently of one another, —(CH₂)₂—, —(CH₂)₃—, —C(CH₃)₂—CH₂—CH(CH₃)— or —O(CH₂)₂—,
Y is SO₂—Y¹ or POY²Y³,
Y¹ is —NH—R⁶ or —NR⁶R⁷,
Y² and Y³ are identical and are each methyl, ethyl, —O—R⁶, —NH—R⁶ or —NR⁶R⁷, or Y² and Y³ together form a —(CH₂)₄— bridge, or
Y² is phenyl and
Y³ is —O—R⁶, —NH—R⁶ or —NR⁶R⁷,
R⁶ and R⁷ are each, independently of one another, methyl, ethyl, propyl, butyl, 2,2,2-trifluoroethyl, 2,2-difluoroethyl, 2,2,3,3-tetrafluoropropyl, 1H,1H-heptafluorobutyl, 1H,1H,4H-hexafluorobutyl, cyclohexyl, allyl, benzyl or phenyl or
NR⁶R⁷ is pyrrolidino, piperidino or morpholino,
M is boron, aluminum or cobalt,
An⁻ is iodide, nitrate, tetrafluoroborate, perchlorate, hexafluorophosphate, methanesulfonate, trifluoromethanesulfonate or the anion or one equivalent of an anion of a rhodamine, oxonol or azo metal complex dye.

In the case of the write-once optical data carrier of the invention which is written on and read by means of the light of a blue laser, preference is given to light-absorbent compounds whose absorption maximum λₘₐₓ₂ is in the range from 420 to 550 nm, where the wavelength λ_{1/2} at which the absorbance in the short wavelength flank of the absorption maximum at the wavelength λₘₐₓ₂ is half of the absorbance value at λₘₐₓ₂ and the wavelength λ_{1/10} at which the absorbance in the short wavelength flank of the absorption maximum at the wavelength λₘₐₓ₂ is one tenth of the absorbance value at λₘₐₓ₂ are preferably not more than 80 nm apart. Such a light-absorbent compound preferably has no shorter-wavelength maximum λₘₐₓ₁ down to a wavelength of 350 nm, particularly preferably down to 320 nm, very particularly preferably down to 290 nm.

Preference is given to light-absorbent compounds having an absorption maximum λₘₐₓ₂ of from 430 to 550 nm, in particular from 440 to 530 nm, very particularly preferably from 450 to 520 nm.

In these light-absorbent compounds, λ_{1/2} and λ_{1/10}, as defined above, are preferably not more than 70 nm apart, particularly preferably not more than 50 nm apart, very particularly preferably not more than 40 nm apart.

In the case of the write-once optical data carrier of the invention which is written on and read by means of the light of a red laser, preference is given to light-absorbent compounds whose absorption maximum λₘₐₓ₂ is in the range from 500 to 650 nm, where the wavelength λ_{1/2} at which the absorbance in the long wavelength flank of the absorption maximum at the wavelength λₘₐₓ₂ is half of the absorbance value at λₘₐₓ₂ and the wavelength λ_{1/10} at which the absorbance in the long wavelength flank of the absorption maximum at the wavelength λₘₐₓ₂ is one tenth of the absorbance value at λₘₐₓ₂ are preferably not more than 60 nm apart. Such a light-absorbent compound preferably has no longer-wavelength maximum λₘₐₓ₃ up to a wavelength of 750 nm, particularly preferably up to 800 nm, very particularly preferably up to 850 nm.

Preference is given to light-absorbent compounds having an absorption maximum λₘₐₓ₂ of from 510 to 620 nm.

Particular preference is given to light-absorbent compounds having an absorption maximum λₘₐₓ₂ of from 530 to 610 nm.

Very particular preference is given to light-absorbent compounds having an absorption maximum λₘₐₓ₂ of from 550 to 600 nm.

In these light-absorbent compounds, λ_{1/2} and λ_{1/10}, as defined above, are preferably not more than 50 nm apart, particularly preferably not more than 40 nm apart, very particularly preferably not more than 30 nm apart.

The light-absorbent compounds preferably have a molar extinction coefficient ε of >30 000 l/mol cm, preferably >50 000 l/mol cm, particularly preferably >70 000 l/mol cm, very particularly preferably >100 000 l/mol cm, at the absorption maximum λₘₐₓ₂.

The absorption spectra are measured, for example, in solution.

Suitable light-absorbent compounds having the required spectral properties are, in particular, those which have a low solvent-induced wavelength shift (dioxane/DMF or methylene chloride/methanol). Preference is given to metal complexes for which the solvent-induced wavelength shift Δλ_{DD}=|λ_{DMF}−λ_{dioxane}|, i.e. the positive difference between the absorption wavelengths in the solvents dimethylformamide and dioxane, or their solvent-induced wavelength shift Δλ_{MM}=|λₘₑₜₕₐₙₒₗ−λ_{methylene chloride}|, i.e. the positive difference between the absorption wavelengths in the solvents methanol and methylene chloride, is <20 nm, particularly preferably <10 nm, very particularly preferably <5 nm.

Preference is given to a write-once optical data carrier according to the invention which is written on and read by means of the light of a red or blue, in particular red, laser.

The azo metal complexes of the invention can also be mixed with other light-absorbent compounds. Light-absorbent compounds having similar spectral properties are preferably selected for this purpose. Such light-absorbent compounds can, for example, come from the following classes of dyes: cyanines, (diaza)hemicyanines, merocyanines, rhodamines, azo dyes, porphyrins, phthalocyanines, sub-phthalocyanines, azo metal complexes. Preference is given to other azo metal complexes.

Examples of other metal complexes are known, e.g. from U.S. Pat. No. B1 6,225,023.

The light-absorbent compounds used according to the invention guarantee a sufficiently high reflectivity (>10%, in particular >20%) of the optical data carrier in the unwritten state and a sufficiently high absorption for thermal degradation of the information layer on point-wise illumination with focussed light if the wavelength of the light is in the range from 360 to 460 nm or from 600 to 680 nm. The contrast between written and unwritten points on the data carrier is achieved by the reflectivity change of the amplitude and also the phase of the incident light due to the changed optical properties of the information layer after the thermal degradation.

The light-absorbent compounds used according to the invention display a high light stability of the unwritten optical data carrier and of the information written on the data carrier toward daylight, sunlight or under intense artificial irradiation intended to imitate daylight.

The light-absorbent compounds used according to the invention likewise display a high sensitivity of the optical data carrier toward blue and red laser light of sufficient energy, so that the data carrier can be written on at high speed (≧2×, ≧4×).

The light-absorbent compounds used according to the invention are sufficiently stable for the disk produced using them generally to pass the required climate test.

The metal complexes of the present invention are preferably applied to the optical data carrier by spin coating or vacuum vapor deposition, in particular spin coating. They can be mixed with one another or else with other dyes having similar spectral properties. The information layer can comprise not only the metal complexes of the invention but also additives such as binders, wetting agents, stabilizers, diluents and sensitizers and also further constituents.

Apart from the information layer, farther layers such as metal layers, dielectric layers, barrier layers and protective layers may be present in the optical data carrier of the invention. Metals and dielectric and/or barrier layers serve, inter alia, to adjust the reflectivity and the heat absorption/retention. Metals can be, depending on the laser wavelength, gold, silver, aluminum, etc. Examples of dielectric layers are silicon dioxide and silicon nitride. Barrier layers are dielectric or metal layers. Protective layers are, for example, photocurable surface coatings, (pressure-sensitive) adhesive layers and protective films.

Pressure-sensitive adhesive layers consist mainly of acrylic adhesives. Nitto Denko DA-8320 or DA-8310, disclosed in the patent JP-A 11-273147, can, for example, be used for this purpose.

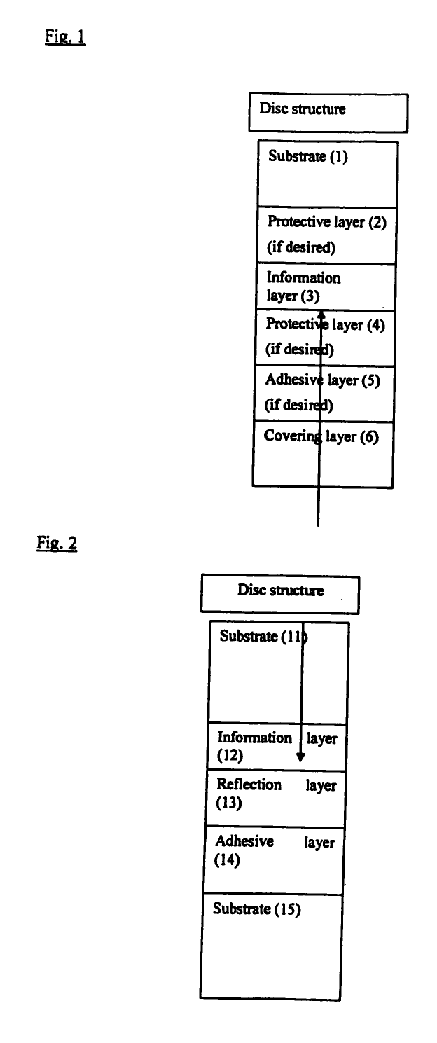

The optical data carrier of the invention has, for example, the following layer structure (cf. FIG. 1): a transparent substrate (1), if desired a protective layer (2), an information layer (3), if desired a protective layer (4), if desired an adhesive layer (5), a covering layer (6). The arrows shown in FIG. 1 and FIG. 2 indicate the path of the incident light.

The structure of the optical data carrier preferably:
comprises a preferably transparent substrate (1) to whose surface at least one light-writeable information layer (3) which can be written on by means of light, preferably laser light, if desired a protective layer (4), if desired an adhesive layer (5) and a transparent covering layer (6) have been applied.
comprises a preferably transparent substrate (1) to whose surface a protective layer (2), at least one information layer (3) which can be written on by means of light, preferably laser light, if desired an adhesive layer (5) and a transparent covering layer (6) have been applied.
comprises a preferably transparent substrate (1) to whose surface a protective layer (2) if desired, at least one information layer (3) which can be written on by means of light, preferably laser light, if desired a protective layer (4), if desired an adhesive layer (5) and a transparent covering layer (6) have been applied.
comprises a preferably transparent substrate (1) to whose surface at least one information layer (3) which can be written on by means of light, preferably laser light, if desired an adhesive layer (5) and a transparent covering layer (6) have been applied.

Alternatively, the optical data carrier has, for example, the following layer structure (cf. FIG. 2): a preferably transparent substrate (11), an information layer (12), if desired a reflection layer (13), if desired an adhesive layer (14), a further preferably transparent substrate (15).

The invention further provides optical data carriers according to the invention which have been written on by means of blue or red light, in particular laser light, especially red laser light.

The following examples illustrate the subject matter of the invention.

### EXAMPLES

### Example 1

a) 6.24 g of N,N-diethyl-m-phenylenediamine were dissolved in 50 ml of 1,2-dichloroethane under a nitrogen atmosphere. 6.4 g of N-propylamidosulfonyl chloride were added, resulting in the temperature rising to 38° C. After stirring for 3 hours at room temperature, the mixture was poured into 200 ml of water and the pH was set to 7.5 by means of 10% strength by weight sodium hydroxide solution. The organic phase was separated off, washed with 50 ml of water, dried over sodium sulfate and evaporated on a rotary evaporator. The oil obtained was extracted three times with 100 ml of methylcyclohexane. This finally left 6.1 g (56% of theory) of a brown oil of the formula 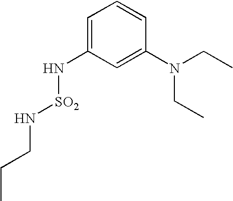
b) 3.68 g of 2-amino4,5-dicyanoimidazole were suspended in a mixture of 110 ml of water and 18.4 ml of 35 percent strength by weight hydrochloric acid. At 0-5° C., 6.2 ml of a sodium nitrite solution containing 30 g of NaNO₂ in 100 ml of water were added dropwise over a period of 1.5 hours. The suspension was stirred at 0-5° C. with a distinct excess of nitrite for another 1 hour.
c) 6.08 g of the aniline derivative from a), 1.1 g of urea and 9.3 g of sodium acetate together with 250 ml of methanol were placed in a reaction vessel. At 0-5° C., the diazotization solution prepared under b) was introduced over a period of 1 hour. The mixture was allowed to come to room temperature overnight while stirring. The solid was then filtered off with suction and dried at 60° C. under reduced pressure. This gave 9.7 g (95% of theory) of the azo dye of the formula 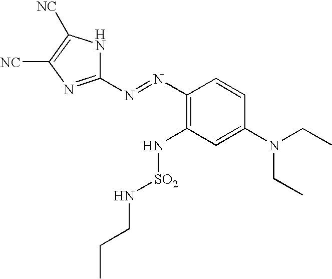
   as a red powder having a melting point of 180° C. (sinters at 105-115° C.).
   λₘₐₓ=494 nm (methanol)
   ε=31 075 l/mol cm.
d) 0.69 g of dimethyl sulfate and 0.76 g of potassium carbonate were added at room temperature to a solution of 2.15 g of the azo dye from c) in 50 ml of methanol. After stirring at room temperature for 2 hours, another 0.69 g of dimethyl sulfate and 0.76 g of potassium carbonate were added. After stirring for another 4 hours, the solid was filtered off with suction, washed with 2×5 ml of methanol and 100 ml of water and dried at 60° C. under reduced pressure. This gave 1.0 g (45% of theory) of a copper-colored powder of the formula 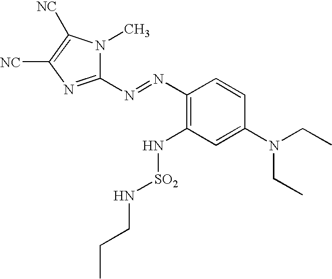
   having a melting point of 239-240° C. (decomp.).
   λₘₐₓ=512 nm (methanol)
   ε=48 035 l/mol cm.
e) 0.67 g of the dye from d) were suspended in 40 ml of methanol at room temperature. 0.19 g of nickel acetate tetrahydrate were added. The mixture was stirred overnight at room temperature, the solid was filtered off with suction and dried at 50° C. under reduced pressure. This gave 0.47 g (65% of theory) of a green powder of the formula 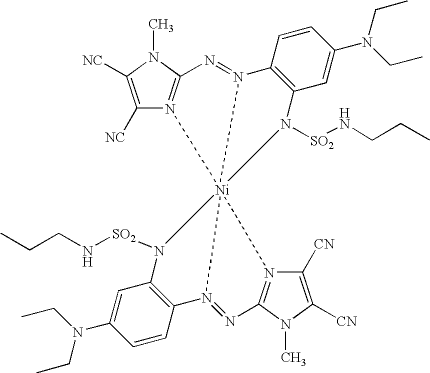
   m.p.>290° C.
   λₘₐₓ=543 nm (chloroform)
   ε=106 055 l/mol cm
   λ_{1/2}-λ_{1/10} (long wavelength flank)=28 rum
   solubility: >2% in TFP (2,2,3,3-tetrafluoropropanol)
   vitreous film
   A further 0.1 g of metal complex of the above formula could be isolated by addition of 2 ml of water to the mother liquor.

### Example 2

a) 21.7 g of N,N-diethyl-m-phenylenediamine were dissolved in 100 ml of carbon tetrachloride. 49.1 g of bis(2,2,3,3-tetrafluoropropyl)phosphinic ester (prepared as described in J. Fluor. Chem. 113 (2002) 65) were added. After cooling to 0-5° C., a mixture of 25 ml of trichlorobromomethane and 25 ml of carbon tetrachloride was added dropwise at this temperature. The semicrystalline mass was stirred at about 10° C. for 1 hour and allowed to stand overnight at room temperature. It was diluted with 200 ml of carbon tetrachloride, the solid was filtered off with suction and washed with 50 ml of carbon tetrachloride. Drying at 40° C. under reduced pressure gave 72.9 g (100% of theory) of a beige-pink powder of the formula 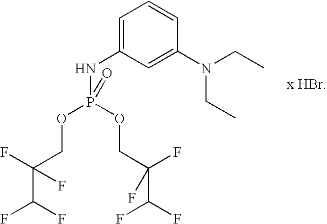
b) 20.0 g of 2-amino-4,5-dicyanoimidazole were suspended in a mixture of 600 ml of water and 100 ml of 35 percent strength by weight hydrochloric acid. At 0-5° C., 33.5 ml of a sodium nitrite solution containing 30 g of NaNO₂ in 100 ml of water were added dropwise over a period of 1.5 hours. The suspension was stirred at 0-5° C. with a distinct excess of nitrite for 1 hour, with 2 ml of the above sodium nitrite solution having to be added during this time.
c) 64 g of the aniline derivative from a), 6 g of urea and 60 g of sodium acetate together with 650 ml of methanol were placed in a reaction vessel. At 0-5° C., the diazotization solution prepared under b) was introduced over a period of 1.5 hours. The mixture was allowed to come to room temperature overnight while stirring. The solid was then filtered off with suction, washed with 100 ml of water and dried at 60° C. under reduced pressure. This gave 63.4 g (89% of theory) of the azo dye of the formula 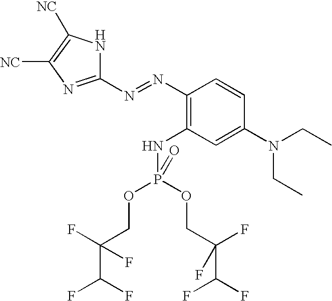
   as a brown powder having a melting point of 126-129° C.
   λₘₐₓ=491 nm (methanol)
   ε=37 295 l/mol cm.
d) 6.94 g of dimethyl sulfate were added dropwise at room temperature to a solution of 30.8 g of the azo dye from c) in 500 ml of methanol over a period of 1 hour. After 1 hour, 7.6 g of potassium carbonate were added. After stirring at room temperature for 3 hours, 6.94 g of dimethyl sulfate and 7.6 g of potassium carbonate were added one hour apart. After stirring for a further 4 hours, the solid was filtered off with suction, washed with 3×10 ml of methanol and 250 ml of water and dried at 60° C. under reduced pressure. This gave 19.5 g (62% of theory) of a Bordeaux-red powder of the formula 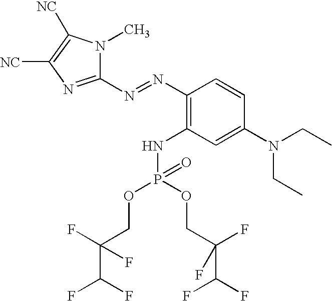
   having a melting point of 200° C.
   λₘₐₓ=519 nm (methanol)
   ε=55 822 l/mol cm.
e) 2 g of the dye from d) were suspended in 70 ml of methanol at room temperature. 0.39 g of nickel acetate tetrahydrate was added. This gave a deep red solution from which product crystallized on stirring overnight. The solid was filtered off with suction and dried at 50° C. under reduced pressure. This gave 0.94 g (44% of theory) of a green powder of the formula 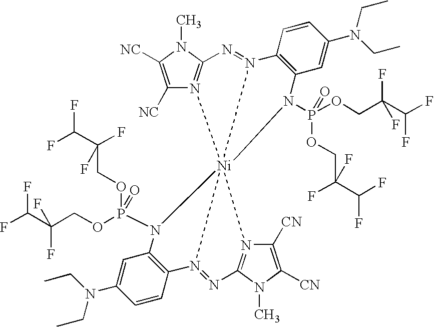
   m.p. 249° C.
   λₘₐₓ=540 nm (chloroform)
   ε=106 024 l/mol cm
   λ_{1/2}-λ_{1/10} (long wavelength flank)=24 nm
   solubility: >2% in TFP (2,2,3,3-tetrafluoropropanol)
   vitreous film
   A further 0.95 g of metal complex of the above formula, but of lower purity, could be isolated by addition of 3 ml of water to the mother liquor.

Azo metal dyes which are likewise suitable are shown in the following table:

Formula (Ia)

| Ex- ample | 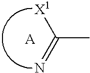 | 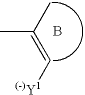 | M | λₘₐₓ/ nm¹⁾ | ε/ l/mol cm | λ_{1/2}-λ_{1/10}/ nm³⁾ | Δλ²⁾/ nm |
|---|---|---|---|---|---|---|---|
| 3 | 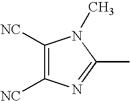 | 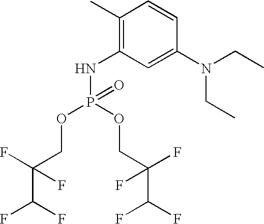 | Co | 538⁵⁾ | 92203 | 33 | |
| 4 | 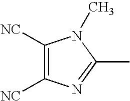 | 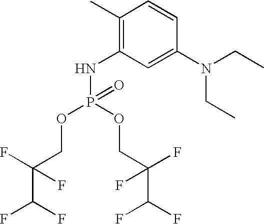 | Cu | 533⁵⁾ | 88071 | 29 | |
| 5 | 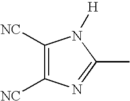 | 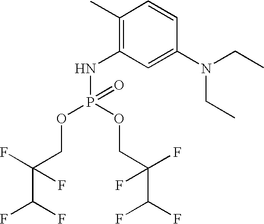 | Ni | 510⁴⁾ | 70893 | 21 | |
| 6 | 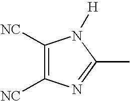 | 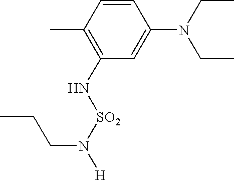 | Ni | 522, 545⁴⁾ | 34523 | 21 | |
| 7 | 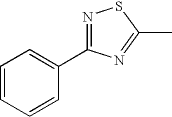 | 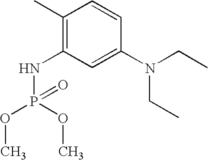 | Ni | 530 | 75341 | 39 | |
| 8 | 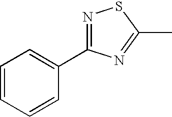 | 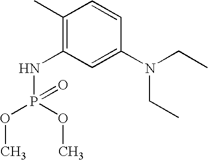 | Co | 542 | 58470 | 48 | |
| 9 | 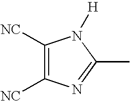 | 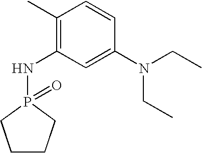 | Ni | | | | |
| 10 | 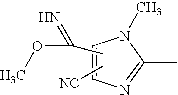 | 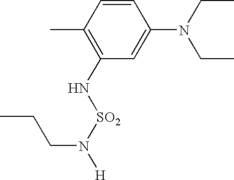 | Ni | 546⁵⁾ | 84279 | 29 | 2 |
| 11 | 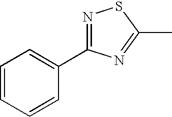 | 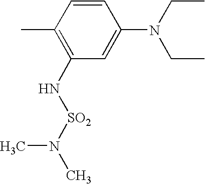 | Ni | 530 | 86514 | | |
| 12 | 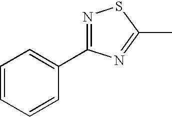 | 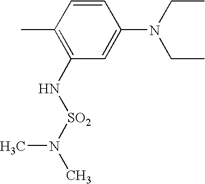 | Co | 551 | 92750 | 32 | |
| 13 | 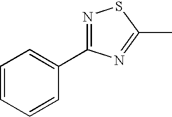 | 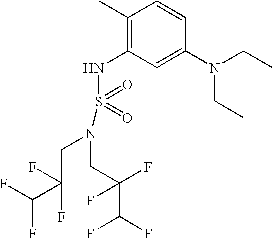 | Co | | | | |
| 14 | 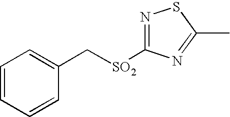 | 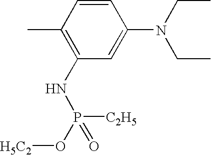 | Co | | | | |
| 15 | 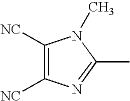 | 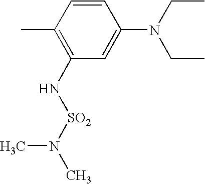 | Ni | 540 | 107238 | 21 | |
| 16 | 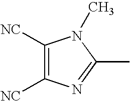 | 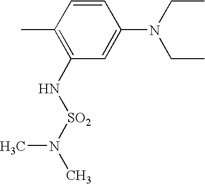 | Co | 543 | 94990 | 33 | |
| 17 | 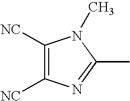 | 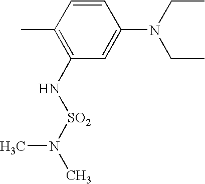 | Zn | 538, 571 | 111931 | 12 | |
| 18 | 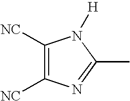 | 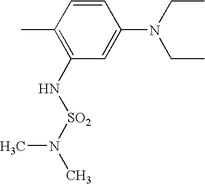 | Ni | 518⁴⁾ | 92143 | 21 | |
| 19 | 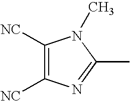 | 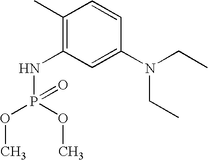 | Co | | | | |
| 20 | 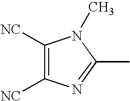 | 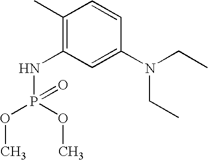 | Cu | | | | |
| 21 | 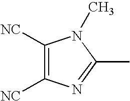 | 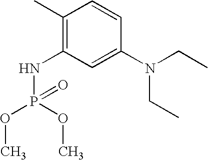 | Zn | | | | |
| 22 | 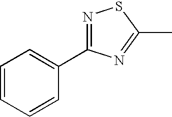 | 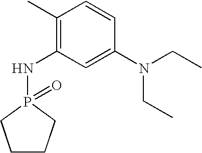 | Ni | | | | |
| 23 | 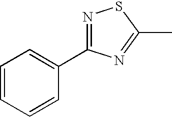 | 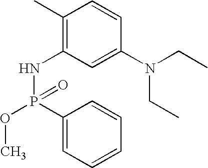 | Ni | 538⁵⁾ | 90126 | 61 | |
| 24 | 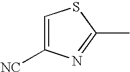 | 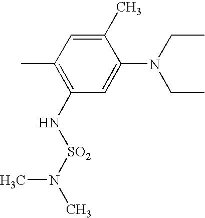 | Zn | | | | |
| 25 | 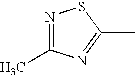 | 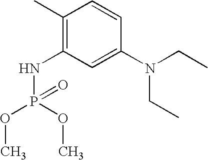 | Ni | 543 | 86640 | 48 | |
| 26 | 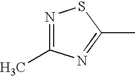 | 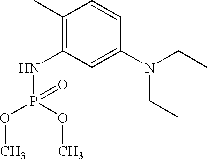 | Co | 555 | 59630 | 55 | |
| 27 | 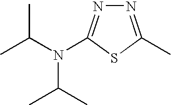 | 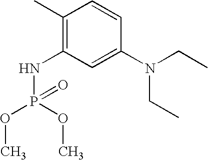 | Ni | 534, 600⁵⁾ | 34782 | | |
| 28 | 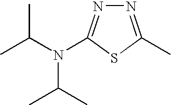 | 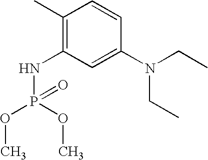 | Co | 583 | 45775 | | |
| 29 | 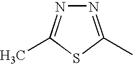 | 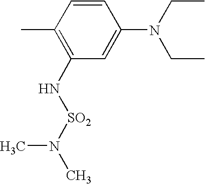 | Ni | 554 | 84070 | 26 | |
| 30 | 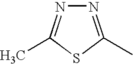 | 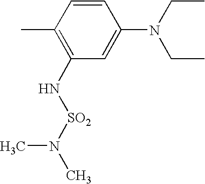 | Co | 554 | | | |
| 31 | 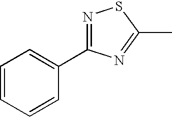 | 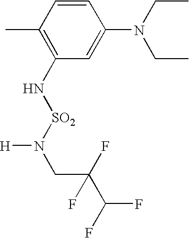 | Ni | 556 | | | |
| 32 | 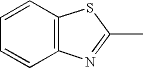 | 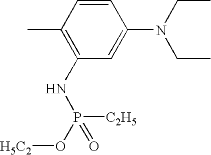 | Co | | | | |
| 33 | 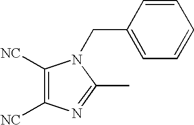 | 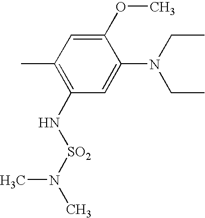 | Ni | | | | |
| 34 | 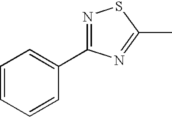 | 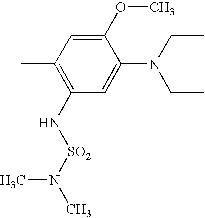 | Zn | 556 | | | |
| 35 | 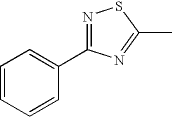 | 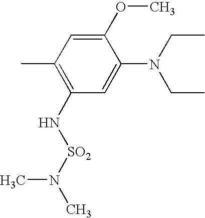 | Ni | 544 | | | |
| 36 | 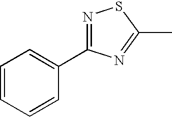 | 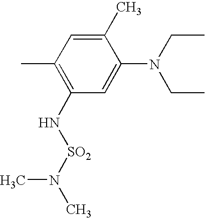 | Ni | 552⁵⁾ | | | |
| 37 | 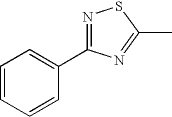 | 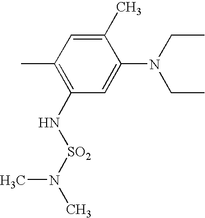 | Zn | 543⁵⁾ | | | |
| 38 | 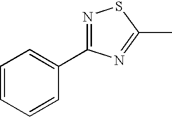 | 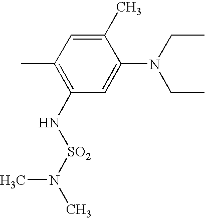 | Co | 554⁵⁾ | | | |
| 39 | 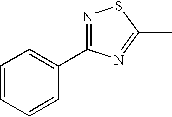 | 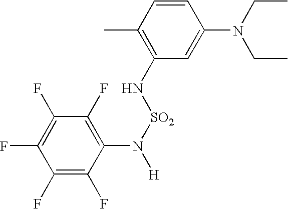 | Ni | 549, 577 | | | |
| 40 | 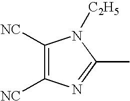 | 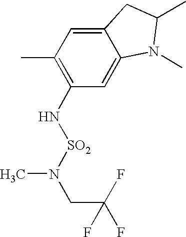 | Ni | | | | |
| 41 | 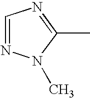 | 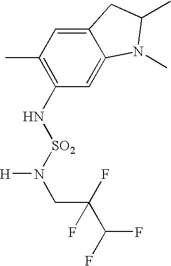 | Ni | | | | |
| 42 | 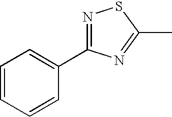 | 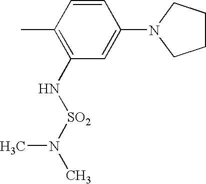 | Ni | | | | |
| 43 | 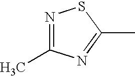 | 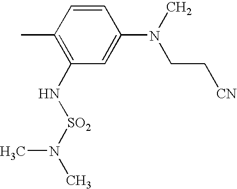 | Ni | | | | |
| 44 | 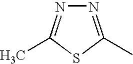 | 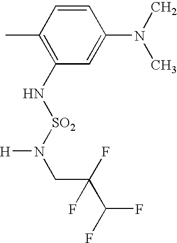 | Co | | | | |
| 45 | 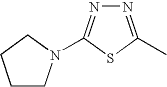 | 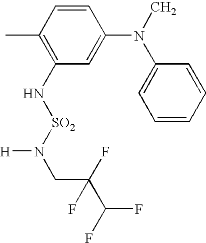 | Ni | | | | |
| 46 | 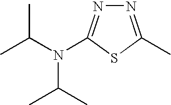 | 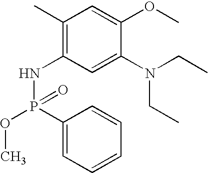 | Ni | | | | |
| 47 | 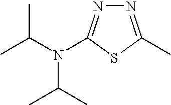 | 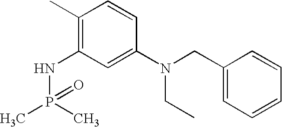 | Zn | | | | |
| 48 | 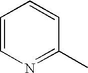 | 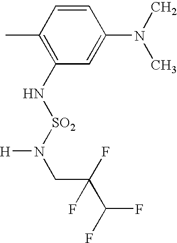 | Ni | | | | |
| 49 | 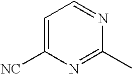 | 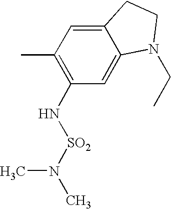 | Cu | | | | |
| 50 | 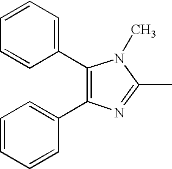 | 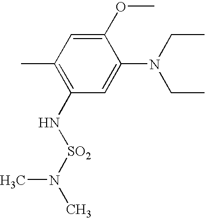 | Zn | | | | |
| 51 | 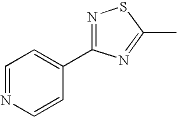 | 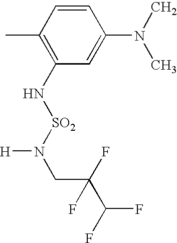 | Ni | | | | |
| 52 | 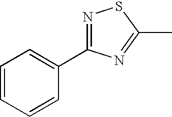 | 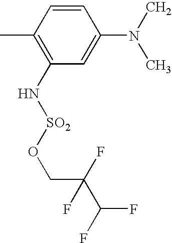 | Ni | | | | |
| 53 | 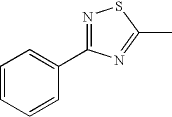 | 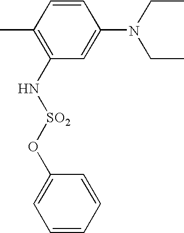 | Ni | | | | |
| 54 | 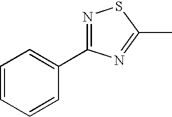 | 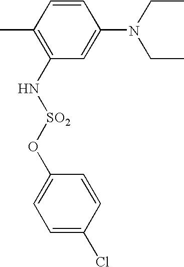 | Cu | | | | |
| 55 | 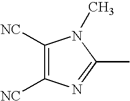 | 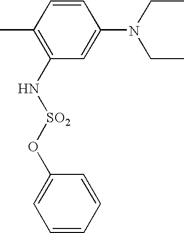 | Ni | | | | |
| 56 | 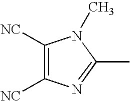 | 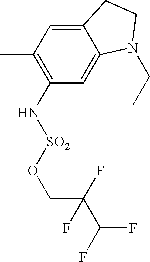 | Ni | | | | |

¹⁾in methylene chloride, unless indicated otherwise.
²⁾Δλ = |λ_{methylene chloride} -λₘₑₜₕₐₙₒₗ|
³⁾on the long wavelength flank
⁴⁾in methanol
⁵⁾in chloroform

### Example 57

a) 41 g of N,N-diethyl-m-phenylenediamine were dissolved in 350 ml of 1,2-dichloroethane under a nitrogen atmosphere. 35.9 g of dimethylamidosulfonyl chloride were added. After stirring at room temperature for 24 hours, 27.7 g of triethylamine and 10 g of dimethylamidosulfonyl chloride were added and the mixture was stirred for another 24 hours at room temperature. The mixture was poured into 1000 ml of water and the pH was set to 7.5 by means of 10% strength by weight sodium hydroxide solution. The organic phase was separated off, washed with 100 ml of water, dried over sodium sulfate and evaporated on a rotary evaporator. The oil obtained was extracted three times with 100 ml of methylcyclohexane. This finally left 47.1 g (61% of theory) of a brown oil of the formula 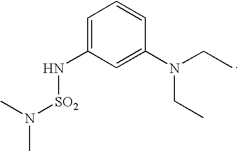
b) 3.26 g of 3-phenyl-5-amino-1,2,4-thiadiazole were dissolved in a mixture of 30 ml of glacial acetic acid and 15 ml of formic acid. At 0-5° C., a solution of 1.28 g of sodium nitrite in 10 ml of water was slowly added dropwise. After 2 hours at 0-5° C., a solution of 5 g of the m-phenylenediamine derivative from a) in 20 ml of glacial acetic acid was slowly added. The mixture was warmed to room temperature and finally heated carefully to 90-95° C. After 1 hour, the mixture was cooled, the solid was filtered off with suction and dried. This gave 3.4 g (40% of theory) of a red dye of the formula 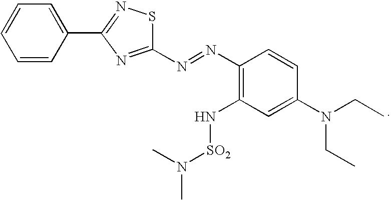
   λₘₐₓ=519 nm (in methylene chloride).
c) 0.14 g of cobalt(II) acetate tetrahydrate together with 10 ml of acetone were placed in a reaction vessel and admixed with 5 drops of 65 percent strength nitric acid. After 1 hour, this solution was added to a solution of 0.5 g of the dye from b) in 10 ml of acetone and the mixture was stirred at 60° C. for 1 hour. After cooling, the mixture was poured into a solution of 0.5 g of lithium perchlorate in 20 ml of water. The precipitated dye was filtered off with suction: 0.44 g (82% of theory). It has the formula 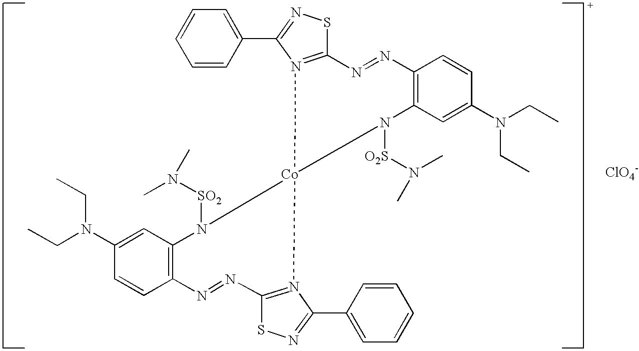
   m.p.=195° C.
   electrospray mass spectrum: m/e=975
   λₘₐₓ=553 nm (in methylene chloride)
   ε=53 510 l/mol cm
   λ_{1/2}−λ_{1/10} (long wavelength flank)=42 nm
   solubility: >2% in TFP (2,2,3,3-tetrafluoropropanol)
   vitreous film

Azo metal dyes which are likewise suitable are shown in the following table:

Formula (Ib)

| Ex- ample | 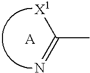 | 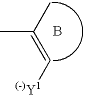 | M | |
|---|---|---|---|---|
| 58 | 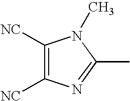 | 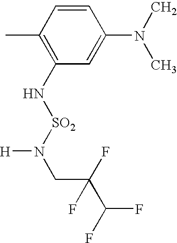 | Co | ClO₄⁻ |
| 59 | 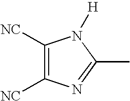 | 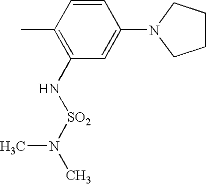 | Co | ClO₄⁻ |
| 60 | 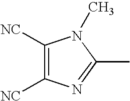 | 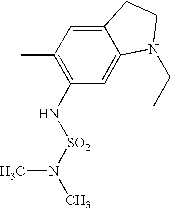 | Co | BF₄⁻ |
| 61 | 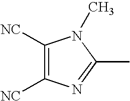 | 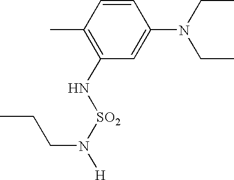 | Co | 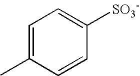 |
| 62 | 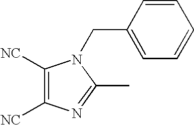 | 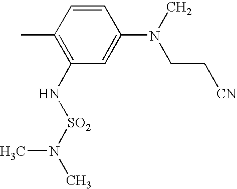 | Co | ClO₄⁻ |
| 63 | 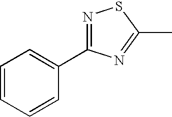 | 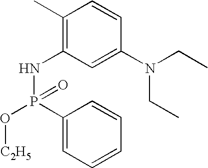 | Co | ClO₄⁻ |
| 64 | 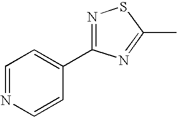 | 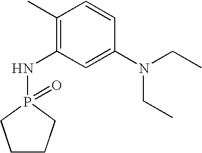 | Co | ClO₄⁻ |
| 65 | 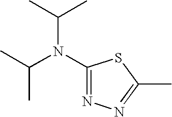 | 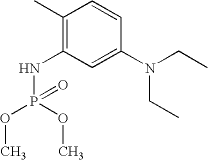 | Co | ClO₄⁻ |
| 66 | 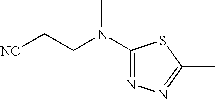 | 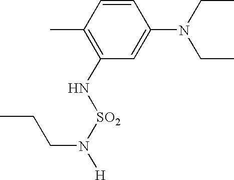 | Co | ClO₄⁻ |
| 67 | 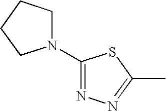 | 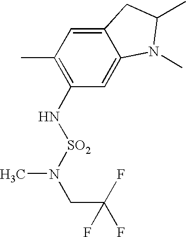 | Co | ClO₄⁻ |
| 68 | 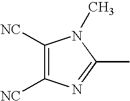 | 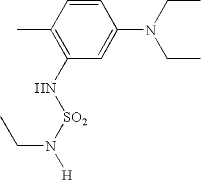 | Co | 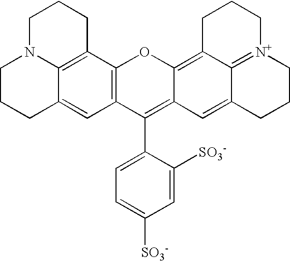 |
| 69 | 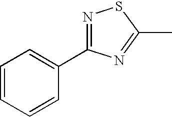 | 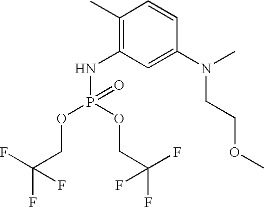 | Co | 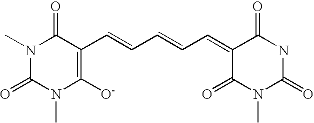 |
| 70 | 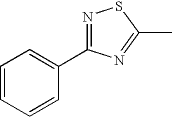 | 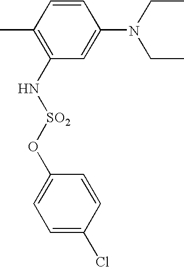 | Ni | ClO₄⁻ |

| Example | λₘₐₓ/nm¹⁾ | ε/l/mol cm | λ_{1/2}-λ_{1/10}/nm | Δλ²⁾/nm |
|---|---|---|---|---|
| 58 | | | | |
| 59 | | | | |
| 60 | | | | |
| 61 | | | | |
| 62 | | | | |
| 63 | | | | |
| 64 | | | | |
| 65 | | | | |
| 66 | | | | |
| 67 | | | | |
| 68 | | | | |
| 69 | | | | |
| 70 | | | | |

¹⁾in methylene chloride, unless indicated otherwise.
²⁾Δλ = |λ_{methylene chloride} -λₘₑₜₕₐₙₒₗ|
³⁾on the long wavelength flank

### Example 71

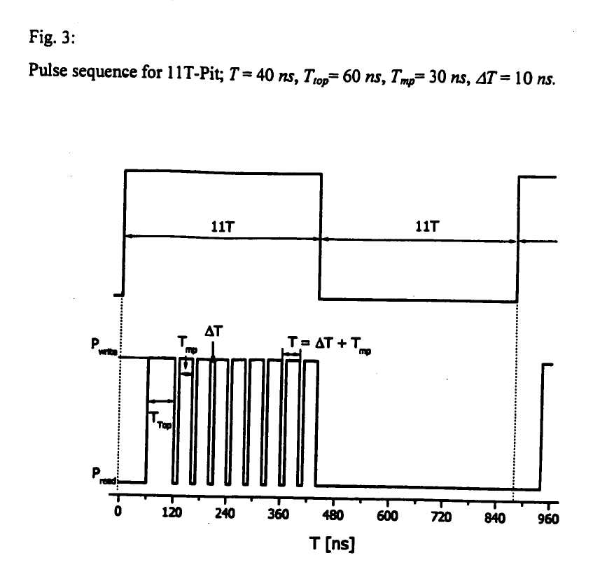

A solution of 2.2 g of dye 1 in 100 ml of 2,2,3,3-tetrafluoropropanol was prepared at room temperature. This solution was applied by means of spin coating to a pregrooved polycarbonate substrate. The pregrooved polycarbonate substrate had been produced as a disk by means of injection molding. The dimensions of the disk and the groove structure corresponded to those customarily used for DVD-Rs. The disk with the dye layer as information carrier was coated with 100 nm of silver by vapor deposition. A UV-curable acrylic coating composition was subsequently applied by spin coating and cured by means of a UV lamp. The disk was tested by means of a dynamic writing test apparatus constructed on an optical test bench comprising a diode laser (λ=656 nm) for generating linearly polarized light, a polarization-sensitive beam splitter, a λ/4 plate and a movably suspended collecting lens having a numerical aperture NA=0.6 (actuator lens). The light reflected from the reflection layer of the disk was taken out from the beam path by means of the abovementioned polarization-sensitive beam splitter and focussed by means of an astigmatic lens onto a four-quadrant detector. At a linear velocity V=3.5 m/s and a writing power P_{write}=10 mW, a signal/noise ratio C/N=51.5 dB was measured for 11 T pits. The writing power was applied as an oscillating pulse sequence (cf. FIG. 3), with the disk being irradiated alternately with the abovementioned writing power P_{write} and the reading power P_{read}≈0.5 mW. The writing pulse sequence for the 11 T pit comprised a lead pulse having a length Tₜₒₚ=1.5 T=60 ns, where T=40 ns is the base time (11 T=440 ns). The lead pulse was placed so that it ended after 3 T units. It was followed by eight pulses having a length Tₘₚ=30 ns, with the time being determined by Tₘₚ=0.75 T. A time interval ΔT=10 ns therefore remains free between each pair of writing pulses. The 11 T long writing pulse was followed by an 11 T long pause. The disk was irradiated with this oscillating pulse sequence until it had rotated once. The marking produced in this way was then read using the reading power P_{read} and the abovementioned signal/noise ratio C/N was measured.

### Example 72

Using a method analogous to Example 71, a solution of 1.8 g of dye 11 in 100 ml of 2,2,3,3-tetrafluoropropanol was prepared at room temperature and a disk having the same structure as described in Example 71 was produced and burned in the same way. A signal/noise ratio C/N=48 dB was measured under the same conditions at a writing power of 10 mW.

### Example 73

Using a method analogous to Example 71, a solution of 2.2 g of dye 15 in 100 ml of 2,2,3,3-tetrafluoropropanol was prepared at room temperature and a disk having the same structure as described in Example 71 was produced and burned in the same way. A signal/noise ratio C/N=53 dB was measured under the same conditions at a writing power of 10 mW.

Analogous results were obtained using the metal complexes from the other examples described above.

1. A metal complex which has at least one ligand of the formula (I) 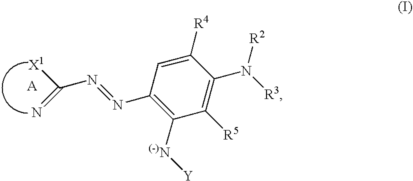
where
X¹ is O, S, N—R¹ or CH,
A together with X¹ and N forms a five- or six-membered aromatic or pseudoaromatic heterocyclic ring which contains from 1 to 4 heteroatoms and/or can be benzo- or naphtho-fused and/or be substituted by nonionic radicals,
R¹ is hydrogen, substituted or unsubstituted C₁-C₁₂-alkyl, substituted or unsubstituted C₃-C₈-cycloalkyl, substituted or unsubstituted C₂-C₁₂-alkenyl or substituted or unsubstituted C₇-C₁₂-aralkyl,
R² and R³ are each, independently of one another, hydrogen, substituted or unsubstituted C₁-C₁₂-alkyl, substituted or unsubstituted C₃-C₈-cycloalkyl, substituted or unsubstituted C₂-C₁₂-alkenyl, substituted or unsubstituted C₂-C₁₂-alkynyl, substituted or unsubstituted C₇-C₁₂-aralkyl, substituted or unsubstituted C₆-C₁₀-aryl or a five- or six-membered heterocyclic ring or
NR²R³ together with the nitrogen atom is a five- to seven-membered heterocyclic ring which may contain further heteroatoms and/or be substituted by nonionic radicals,
R⁴ and R⁵ are each, independently of one another, hydrogen, halogen, substituted or unsubstituted C₁-C₆-alkyl, substituted or unsubstituted C₁-C₆-alkoxy or substituted or unsubstituted C₁-C₆-alkylthio or
R²; R⁴ and R³; R⁵ are each, independently of one another, a divalent to tetravalent bridge which may contain further heteroatoms and/or be substituted by nonionic radicals,
Y is SO₂—Y¹ or POY²Y³,
Y¹ is —O—R⁶, —NH—R⁶ or NR⁶R⁷,
Y² and Y³ are each, independently of one another, substituted or unsubstituted C₁-C₁₂-alkyl, substituted or unsubstituted C₆-C₁₀-aryl, a substituted or unsubstituted five- or six-membered pseudoaromatic or aromatic heterocyclic radical, —O—R⁶, —NH—R⁶ or NR⁶R⁷, or Y² and Y³ together form a bridge,
R⁶ and R⁷ are each, independently of one another, substituted or unsubstituted C₁-C₁₂-alkyl, substituted or unsubstituted C₃-C₈-cycloalkyl, substituted or unsubstituted C₂-C₁₂-alkenyl, substituted or unsubstituted C₂-C₁₂-alkynyl, substituted or unsubstituted C₇-C₁₂-aralkyl, substituted or unsubstituted C₆-C₁₀-aryl or a five- or six-membered heterocyclic ring or
NR⁶R⁷ together with the nitrogen atom is a five- to seven-membered heterocyclic ring which may contain further heteroatoms and/or be substituted by nonionic radicals,
or a metal complex which has at least one ligand of the formula (LI) 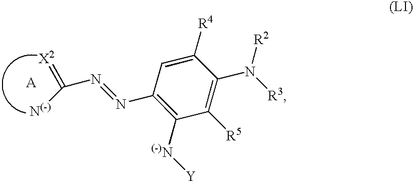
where
X² is N or CH
and the other radicals are as described above.

2. The metal complex as claimed in claim 1, characterized in that it contains two identical or different ligands of the formula (I) or (LI).

3. The metal complex as claimed in at least one of claims 1 to 2, characterized in that it has the formula (Ia)
[(I)]₂⁻M²⁺ (Ia)
where the two ligands of the formula (I) have, independently of one another, one of the meanings given in claim 1 and
M is a metal, or
have the formula (Ib)
[(I)]₂⁻M³⁺An⁻ (Ib)
where the two ligands of the formula (I) have, independently of one another, one of the meanings given above and
M is a metal and
An⁻ is an anion.

4. The metal complex as claimed in at least one of claims 1 to 3, characterized in that it has the formula (Ia)
[(I)]₂^{-M}²⁺ (Ia)
where the two ligands of the formula (I) have, independently of one another, one of the meanings given in claim 1 and
M is a metal.

5. The metal complex as claimed in at least one of claims 1 to 4, characterized in that the metal is a divalent metal, transition metal or rare earth, in particular Mg, Ca, Sr, Ba, Cu, Ni, Co, Fe, Zn, Pd, Pt, Ru, Rh, Th, Os, Sm, Eu.

6. The metal complex as claimed in at least one of claims 1 to 5, characterized in that the metal is Pd, Fe, Zn, Cu, Ni or Co.

7. The metal complex as claimed in at least one of claims 1 to 6, characterized in that the metal is a trivalent metal, transition metal or rare earth, in particular B, Al, Ga, In, V, Co, Cr, Fe, Y, La, Ce, Pr, Nd, Sm, Eu, Gd, Tb.

8. The metal complex as claimed in at least one of claims 1 to 7, characterized in that the metal is B, Al or Co.

9. The metal complex as claimed in at least one of claims 1 to 8, characterized in that, in the formula (I)
the ring A of the formula (III) 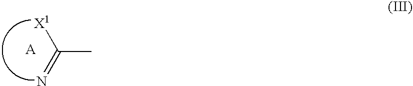
is benzothiazol-2-yl which may bear up to three identical or different radicals selected from the group consisting of chloro, methyl, methoxy, ethoxy, cyano and nitro as substituents, benzimidazol-2-yl which may bear up to three identical or different radicals selected from the group consisting of chloro, methyl, methoxy, ethoxy, cyano and nitro as substituents, thiazol-2-yl which may bear up to two identical or different radicals selected from the group consisting of chloro, fluoro, methyl, trifluoromethyl, methoxy, phenyl, cyano, nitro, methoxycarbonyl, methanesulfonyl, formyl and the divalent radical of the formula —(CH₂)₄— as substituents, thiazol-4-yl which may bear up to two identical or different radicals selected from the group consisting of chloro, fluoro, methoxy, methylthio, phenyl and cyano as substituents, imidazol-2-yl which may bear up to two identical or different radicals selected from the group consisting of fluoro, chloro, methyl, trifluoromethyl, methoxy, phenyl, cyano, nitro, CH₃O—(C═NH)—, methoxycarbonyl and ethoxycarbonyl as substituents, pyrazol-5-yl which may bear up to two identical or different radicals selected from the group consisting of chloro, methyl, methoxy, phenyl, cyano and nitro as substituents, 1,2,4-thiadiazol-3-yl which may bear a methyl or phenyl substituent, 1,3,4-thiadiazol-2-yl which may bear a chloro, bromo, methoxy, phenoxy, methanesulfonyl, methylthio, ethylthio, dimethylamino, diethylamino, di(iso)propylamino, N-methyl-N-cyanoethylamino, N,N-biscyanoethylamino, N-methyl-N-hydroxyethylamino, N-methyl-N-benzylamino, N-methyl-N-phenylamino, anilino, pyrrolidino, piperidino or morpholino substituent, 1,2,4-thiadiazol-5-yl which may bear a chloro, methyl, methoxy, phenoxy, methylthio, methanesulfonyl, phenyl, dimethylamino or anilino substituent, 1,3,4-triazol-2-yl which may bear a methyl or phenyl substituent, 2-pyridyl which may bear chloro, methyl, methoxy, cyano, methoxycarbonyl or nitro substituents, 2-quinolyl which may bear chloro, methyl, methoxy, cyano, methoxycarbonyl or nitro substituents, 2-pyrimidyl which may bear up to three identical or different radicals selected from the group consisting of chloro, methyl, methoxy, cyano, methoxycarbonyl and nitro as substituents, 1,3,5-triazin-2-yl or 2-pyrazinyl,
where
X¹ is O, S, N—R¹ or CH,
R¹ is hydrogen, methyl, ethyl, propyl, butyl, allyl, benzyl, phenethyl or phenylpropyl,
R²and R³ are each, independently of one another, hydrogen, methyl, ethyl, propyl, butyl, hydroxyethyl, cyanoethyl, cyclopentyl, cyclohexyl, allyl, benzyl, phenethyl, phenylpropyl, phenyl, tolyl, chlorophenyl or anisyl or
NR²R³ is pyrrolidino, piperidino or morpholino,
R⁴ is hydrogen, chlorine, methyl, methoxy or methylthio,
R⁵ is hydrogen or methyl or R²; R⁴ and R³; R⁵ are each, independently of one another, —(CH₂)₂—, —(CH₂)₃—, —C(CH₃)₂—CH₂—CH(CH₃)— or —O(CH₂)₂—,
Y is SO₂—Y¹ or POY²Y³,
Y¹ is —NH—R⁶ or —NR⁶R⁷,
Y² and Y³ are identical and are each methyl, ethyl, —O—R⁶, —NH—R⁶ or —NR⁶R⁷, or Y² and Y³ together form a —(CH₂)₄— bridge, or
Y² is phenyl and
Y³ is —O—R⁶, —NH—R⁶ or —NR⁶R⁷,
R⁶ and R⁷ are each, independently of one another, methyl, ethyl, propyl, butyl, 2,2,2-trifluoroethyl, 2,2-difluoroethyl, 2,2,3,3-tetrafluoropropyl, 1H,1H-heptafluorobutyl, 1H,1H,4H-hexafluorobutyl, cyclohexyl, allyl, benzyl or phenyl or
NR⁶R⁷ is pyrrolidino, piperidino or morpholino,
M is nickel, zinc, copper, cobalt, iron or palladium or
M is boron, aluminum or cobalt and
An⁻ is iodide, nitrate, tetrafluoroborate, perchlorate, hexafluorophosphate, methanesulfonate, trifluoromethanesulfonate or the anion or one equivalent of an anion of a rhodamine, oxonol or azo metal complex dye.

10. The metal complex as claimed in at least one of claims 1 to 9, characterized in that
the ring A of the formula (III) 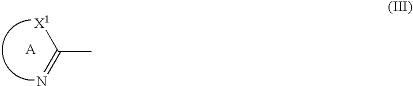
is benzothiazol-2-yl, chlorobenzothiazol-2-yl, methylbenzothiazol-2-yl, methoxybenzothiazol-2-yl or nitrobenzothiazol-2-yl, benzimidazol-2-yl, thiazol-2-yl, phenylthiazol-2-yl, cyanothiazol-2-yl, nitrothiazol-2-yl, 5-fluoro-4-trifluoromethylthiazol-2-yl, 5-phenyl-4-trifluoromethylthiazol-2-yl, 2-methylthio-5-cyano-thiazol-4-yl, imidazol-2-yl, 4,5-diphenylimidazol-2-yl, 4,5-dicyanoimidazol-2-yl, 4,5-bis-methoxycarbonylimidazol-2-yl or 4,5-bis-ethoxycarbonylimidazol-2-yl, pyrazol-5-yl, 1,3,4-thiadiazol-2-yl, 5-phenoxy-1,3,4-thiadiazol-2-yl, 5-methylthio-1,3,4-thiadiazol-2-yl, 5-dimethylamino-1,3,4-thiadiazol-2-yl, 5-diethylamino-1,3,4-thiadiazol-2-yl, 5-di(iso)-propylamino-1,3,4-thiadiazol-2-yl, 5-N-methyl-N-cyanoethylamino-1,3,4-thiadiazol-2-yl, 5-pyrrolidino-1,3,4-thiadiazol-2-yl, 5-phenyl-1,3,4-thiadiazol-2-yl, 5-methyl-1,3,4-thiadiazole, 1,2,4-thiadiazol-5-yl, 3-methylthio-1,2,4-thiadiazol-5-yl, 3-methanesulfonyl-1,2,4-thiadiazol-5-yl, 3-phenyl-1,2,4-thiadiazol-5-yl, 1,3,4-triazol-2-yl, 2-pyridyl, 2-quinolyl, 2-pyrimidyl, 4-cyano-2-pyrimidyl, 4,6-dicyano-2-pyrimidyl, 1,3,5-triazin-2-yl or 2-pyrazinyl,
in which
X¹ is O, S, N—R¹ or CH,
R¹ is hydrogen, methyl, ethyl or benzyl,
R² and R³ are each, independently of one another, methyl, ethyl, cyanoethyl, cyclohexyl, benzyl or phenyl or
NR²R³ is pyrrolidino, piperidino or morpholino,
R⁴ is hydrogen, methyl or methoxy,
R⁵ is hydrogen or
R²; R⁴ is —(CH₂)₂— or —(CH₂)₃—,
Y is SO₂—Y¹ or POY²Y³,
Y¹ is —NH—R⁶ or —NR⁶R⁷,
Y² and Y³ are identical and are each —O—R⁶,
R⁶ and R⁷ are each, independently of one another, methyl, ethyl, 2,2,2-trifluoroethyl, 2,2-difluoroethyl, 2,2,3,3-tetrafluoropropyl, benzyl or phenyl or
NR⁶R⁷ is pyrrolidino, piperidino or morpholino,
M is nickel, zinc, copper or cobalt or
M is cobalt and
An⁻ is iodide, nitrate, tetrafluoroborate, perchlorate, hexafluorophosphate or the anion of the formula

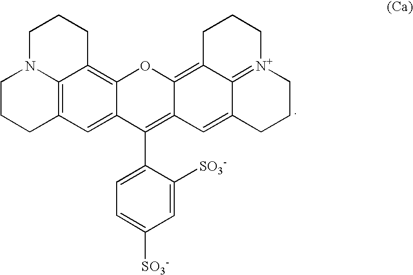

11. A process for preparing metal complexes as claimed in claim 1, characterized in that a metal salt is reacted with an azo compound of the formula (Ic) 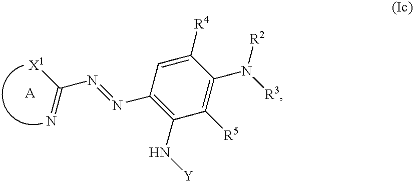
in which
X¹ is O, S, N—R¹ or CH,
A together with X¹ and N forms a five- or six-membered aromatic or pseudoaromatic heterocyclic ring which contains from 1 to 4 heteroatoms and/or can be benzo- or naphtho-fused and/or be substituted by nonionic radicals,
R¹ is hydrogen, substituted or unsubstituted C₁-C₁₂-alkyl, substituted or unsubstituted C₃-C₈-cycloalkyl, substituted or unsubstituted C₂-C₁₂-alkenyl or substituted or unsubstituted C₇-C₁₂-aralkyl,
R² and R³ are each, independently of one another, hydrogen, substituted or unsubstituted C₁-C₁₂-alkyl, substituted or unsubstituted C₃-C₈-cycloalkyl, substituted or unsubstituted C₂-C₁₂-alkenyl, substituted or unsubstituted C₂-C₁₂-alkynyl, substituted or unsubstituted C₇-C₁₂-aralkyl, substituted or unsubstituted C₆-C₁₀-aryl or a five- or six-membered heterocyclic ring or
NR²R³ together with the nitrogen atom is a five- to seven-membered heterocyclic ring which may contain further heteroatoms and/or be substituted by nonionic radicals,
R⁴ and R⁵ are each, independently of one another, hydrogen, halogen, substituted or unsubstituted C₁-C₆-alkyl, substituted or unsubstituted C₁-C₆-alkoxy or substituted or unsubstituted C₁-C₆-alkylthio or
R²; R⁴ and R³; R⁵ are each, independently of one another, a divalent to tetravalent bridge which may contain further heteroatoms and/or be substituted by nonionic radicals,
Y is SO₂—Y¹ or POY²Y³,
Y¹ is —O—R⁶, —NH—R⁶ or NR⁶R⁷,
Y² and Y³ are each, independently of one another, substituted or unsubstituted C₁-C₁₂-alkyl, substituted or unsubstituted C₆-C₁₀-aryl, a substituted or unsubstituted five- or six-membered pseudoaromatic or aromatic heterocyclic radical, —O—R⁶, —NH—R⁶ or NR⁶R⁷, or Y² and Y³ together form a bridge,
R⁶ and R⁷ are each, independently of one another, substituted or unsubstituted C₁-C₁₂-alkyl, substituted or unsubstituted C₃-C₈-cycloalkyl, substituted or unsubstituted C₂-C₁₂-alkenyl, substituted or unsubstituted C₂-C₁₂-alkynyl, substituted or unsubstituted C₇-C₁₂-aralkyl, substituted or unsubstituted C₆-C₁₀-aryl or a five- or six-membered heterocyclic ring or
NR⁶R⁷ together with the nitrogen atom is a five- to seven-membered heterocyclic ring which may contain further heteroatoms and/or be substituted by nonionic radicals.

12. The use of a metal complex as claimed in at least one of claims 1 to 10 as a light-absorbent compound in the information layer of write-once optical data carriers.

13. The use as claimed in claim 12, characterized in that the optical data carrier can be written on and read by means of blue laser light, in particular laser light having a wavelength in the range 360-460 nm.

14. The use as claimed in at least one of claims 12 or 13, characterized in that the optical data carrier can be written on and read by means of red laser light, in particular laser light having a wavelength in the range 600-700 nm.

15. The use of a metal complex of azo ligands as a light-absorbent compound in the information layer of write-once optical data carriers which can be written on and read by means of blue laser light, in particular laser light having a wavelength in the range 360-460 nm.

16. An azo compound of the formula (Ic) 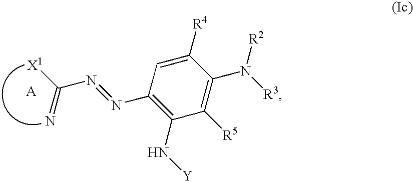
where
X¹ is O, S, N—R¹ or CH,
A together with X¹ and N forms a five- or six-membered aromatic or pseudoaromatic heterocyclic ring which contains from 1 to 4 heteroatoms and/or can be benzo- or naphtho-fused and/or be substituted by nonionic radicals,
R¹ is hydrogen, substituted or unsubstituted C₁-C₁₂-alkyl, substituted or unsubstituted C₃-C₈-cycloalkyl, substituted or unsubstituted C₂-C₁₂-alkenyl or substituted or unsubstituted C₇-C₁₂-aralkyl,
R² and R³ are each, independently of one another, hydrogen, substituted or unsubstituted C₁-C₁₂-alkyl, substituted or unsubstituted C₃-C₈-cycloalkyl, substituted or unsubstituted C₂-C₁₂-alkenyl, substituted or unsubstituted C₂-C₁₂-alkynyl, substituted or unsubstituted C₇-C₁₂-aralkyl, substituted or unsubstituted C₆-C₁₀-aryl or a five- or six-membered heterocyclic ring or
NR²R³ together with the nitrogen atom is a five- to seven-membered heterocyclic ring which may contain further heteroatoms and/or be substituted by nonionic radicals,
R⁴ and R⁵ are each, independently of one another, hydrogen, halogen, substituted or unsubstituted C₁-C₆-alkyl, substituted or unsubstituted C₁-C₆-alkoxy or substituted or unsubstituted C₁-C₆-alkylthio or
R²; R⁴ and R³; R⁵ are each, independently of one another, a divalent to tetravalent bridge which may contain further heteroatoms and/or be substituted by nonionic radicals,
Y is SO₂—Y¹ or POY²Y³,
Y¹ is —O—R⁶, —NH—R⁶ or NR⁶R⁷,
Y² and Y³ are each, independently of one another, substituted or unsubstituted C₁-C₁₂-alkyl, substituted or unsubstituted C₆-C₁₀-aryl, a substituted or unsubstituted five- or six-membered pseudoaromatic or aromatic heterocyclic radical, —O—R⁶, —NH—R⁶ or NR⁶R⁷, or Y² and Y³ together form a bridge,
R⁶ and R⁷ are each, independently of one another, substituted or unsubstituted C₁-C₁₂-alkyl, substituted or unsubstituted C₃-C₈-cycloalkyl, substituted or unsubstituted C₂-C₁₂-alkenyl, substituted or unsubstituted C₂-C₁₂-alkynyl, substituted or unsubstituted C₇-C₁₂-aralkyl, substituted or unsubstituted C₆-C₁₀-aryl or a five- or six-membered heterocyclic ring or
NR⁶R⁷ together with the nitrogen atom is a five- to seven-membered heterocyclic ring which may contain further heteroatoms and/or be substituted by nonionic radicals.

17. The azo compound as claimed in claim 16, characterized in that, in the formula (Ic),
the ring A of the formula (III) 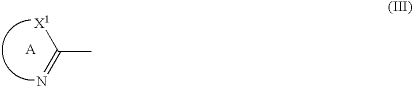
is benzothiazol-2-yl which may bear up to three identical or different radicals selected from the group consisting of chloro, methyl, methoxy, ethoxy, cyano and nitro as substituents, benzimidazol-2-yl which may bear up to three identical or different radicals selected from the group consisting of chloro, methyl, methoxy, ethoxy, cyano and nitro as substituents, thiazol-2-yl which may bear up to two identical or different radicals selected from the group consisting of chloro, fluoro, methyl, trifluoromethyl, methoxy, phenyl, cyano, nitro, methoxycarbonyl, methanesulfonyl, formyl and the divalent radical of the formula —(CH₂)₄— as substituents, thiazol-4-yl which may bear up to two identical or different radicals selected from the group consisting of chloro, fluoro, methoxy, methylthio, phenyl and cyano as substituents, imidazol-2-yl which may bear up to two identical or different radicals selected from the group consisting of fluoro, chloro, methyl, trifluoromethyl, methoxy, phenyl, cyano, nitro, CH₃O—(C═NH)—, methoxycarbonyl and ethoxycarbonyl as substituents, pyrazol-5-yl which may bear up to two identical or different radicals selected from the group consisting of chloro, methyl, methoxy, phenyl, cyano and nitro as substituents, 1,3,4-thiadiazol-2-yl which may bear a chloro, bromo, methoxy, phenoxy, methanesulfonyl, methylthio, ethylthio, dimethylamino, diethylamino, di(iso)propylamino, N-methyl-N-cyanoethylamino, N,N-biscyanoethylamino, N-methyl-N-hydroxyethylamino, N-methyl-N-benzylamino, N-methyl-N-phenylamino, anilino, pyrrolidino, piperidino or morpholino substituent, 1,2,4-thiadiazol-3-yl which may bear a methyl or phenyl substituent, 1,2,4-thiadiazol-5-yl which may bear a chloro, methyl, methoxy, phenoxy, methylthio, methanesulfonyl, phenyl, dimethylamino or anilino substituent, 1,3,4-triazol-2-yl which may bear a methyl or phenyl substituent, 2-pyridyl which may bear chloro, methyl, methoxy, cyano, methoxycarbonyl or nitro substituents, 2-quinolyl which may bear chloro, methyl, methoxy, cyano, methoxycarbonyl or nitro substituents, 2-pyrimidyl which may bear up to three identical or different radicals selected from the group consisting of chloro, methyl, methoxy, cyano, methoxycarbonyl and nitro as substituents, 1,3,5-triazin-2-yl or 2-pyrazinyl,
where
X¹ is O, S, N—R¹ or CH,
R¹ is hydrogen, methyl, ethyl, propyl, butyl, allyl, benzyl, phenethyl or phenylpropyl,
R² and R³ are each, independently of one another, hydrogen, methyl, ethyl, propyl, butyl, hydroxyethyl, cyanoethyl, cyclopentyl, cyclohexyl, allyl, benzyl, phenethyl, phenylpropyl, phenyl, tolyl, chlorophenyl or anisyl or
NR²R³ is pyrrolidino, piperidino or morpholino,
R⁴ is hydrogen, chlorine, methyl, methoxy or methylthio,
R⁵ is hydrogen or methyl or
R²; R⁴ and R³; R⁵ are each, independently of one another, —(CH₂)₂—, —(CH₂)₃—, —C(CH₃)₂—CH₂—CH(CH₃)— or —O(CH₂)₂—,
Y is SO₂—Y¹ or POY₂Y³,
Y¹ is —NH—R⁶ or —NR⁶R⁷,
Y² and Y³ are identical and are each methyl, ethyl, —O—R⁶, —NH—R⁶ or —NR⁶R⁷, or Y² and Y³ together form a —(CH₂)₄— bridge, or
Y² is phenyl and
Y³ is —O—R⁶, —NH—R⁶ or —NR⁶R⁷,
R⁶ and R⁷ are each, independently of one another, methyl, ethyl, propyl, butyl, 2,2,2-trifluoroethyl, 2,2-difluoroethyl, 2,2,3,3-tetrafluoropropyl, 1H,1H-heptafluorobutyl, 1H,1H,4H-hexafluorobutyl, cyclohexyl, allyl, benzyl or phenyl or
NR⁶R⁷ is pyrrolidino, piperidino or morpholino.

18. The azo compound as claimed in claim 16 or 17, characterized in that
the ring A of the formula (III) 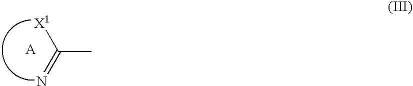
is benzothiazol-2-yl, chlorobenzothiazol-2-yl, methylbenzothiazol-2-yl, methoxybenzothiazol-2-yl or nitrobenzothiazol-2-yl, benzimidazol-2-yl, thiazol-2-yl, phenylthiazol-2-yl, cyanothiazol-2-yl, nitrothiazol-2-yl, 5-fluoro-4-trifluoromethylthiazol-2-yl, 5-phenyl-4-trifluoromethylthiazol-2-yl, 2-methylthio-5-cyano-thiazol-4-yl, imidazol-2-yl, 4,5-diphenylimidazol-2-yl, 4,5-dicyanoimidazol-2-yl, 4,5-bis-methoxycarbonylimidazol-2-yl or 4,5-bis-ethoxycarbonylimidazol-2-yl, pyrazol-5-yl, 1,3,4-thiadiazol-2-yl, 5-phenoxy-1,3,4-thiadiazol-2-yl, 5-methylthio-1,3,4-thiadiazol-2-yl, 5-dimethylamino-1,3,4-thiadiazol-2-yl, 5-diethylamino-1,3,4-thiadiazol-2-yl, 5-di(iso)propylamino-1,3,4-thiadiazol-2-yl, 5-N-methyl-N-cyanoethylamino-1,3,4-thiadiazol-2-yl, 5-pyrrolidino-1,3,4-thiadiazol-2-yl, 5-phenyl-1,3,4-thiadiazol-2-yl, 5-methyl-1,3,4-thiadiazole, 1,2,4-thiadiazol-5-yl, 3-methylthio-1,2,4-thiadiazol-5-yl, 3-methanesulfonyl-1,2,4-thiadiazol-5-yl, 3-phenyl-1,2,4-thiadiazol-5-yl, 1,3,4-triazol-2-yl, 2-pyridyl, 2-quinolyl, 2-pyrimidyl, 4-cyano-2-pyrimidyl, 4,6-dicyano-2-pyrimidyl, 1,3,5-triazin-2-yl or 2-pyrazinyl,
in which
X¹ is O, S, N—R¹ or CH,
R¹ is hydrogen, methyl, ethyl or benzyl,
R² and R³ are each, independently of one another, methyl, ethyl, cyanoethyl, cyclohexyl, benzyl or phenyl or
NR²R³ is pyrrolidino, piperidino or morpholino,
R⁴ is hydrogen, methyl or methoxy,
R⁵ is hydrogen or
R²; R⁴ is —(CH₂)₂— or —(CH₂)₃—,
Y is SO₂—Y¹ or POY²Y³,
Y¹ is —NH—R⁶ or —NR⁶R⁷,
Y² and Y³ are identical and are each —O—R⁶,
R⁶ and R⁷ are each, independently of one another, methyl, ethyl, 2,2,2-trifluoroethyl, 2,2-difluoroethyl, 2,2,3,3-tetrafluoropropyl, benzyl or phenyl or
NR⁶R⁷ is pyrrolidino, piperidino or morpholino.

19. A process for preparing an azo compound of the formula (Ic), as claimed in claim 15, characterized in that an aminoheterocycle of the formula (IV) 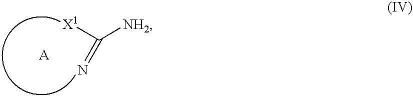
where
X¹ is O, S, N—R¹ or CH,
A together with X¹ and N forms a five- or six-membered aromatic or pseudoaromatic heterocyclic ring which contains from 1 to 4 heteroatoms and/or may be benzo- or naphtho-fused and/or be substituted by nonionic radicals,
R¹ is hydrogen, substituted or unsubstituted C₁-C₁₂-alkyl, substituted or unsubstituted C₃-C₈-cycloalkyl, substituted or unsubstituted C₂-C₁₂-alkenyl or substituted or unsubstituted C₇-C₁₂-aralkyl,
is diazotized or nitrosated and coupled with a coupling component of the formula (V) 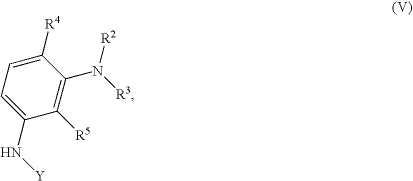
where
R² and R³ are each, independently of one another, hydrogen, substituted or unsubstituted C₁-C₁₂-alkyl, substituted or unsubstituted C₃-C₈-cycloalkyl, substituted or unsubstituted C₂-C₁₂-alkenyl, substituted or unsubstituted C₂-C₁₂-alkynyl, substituted or unsubstituted C₇-C₁₂-aralkyl, substituted or unsubstituted C₆-C₁₀-aryl or a five- or six-membered heterocyclic ring or
NR²R³ together with the nitrogen atom is a five- to seven-membered heterocyclic ring which may contain further heteroatoms and/or be substituted by nonionic radicals,
R⁴ and R⁵ are each, independently of one another, hydrogen, halogen, substituted or unsubstituted C₁-C₆-alkyl, substituted or unsubstituted C₁-C₆-alkoxy or substituted or unsubstituted C₁-C₆-alkylthio or
R²; R⁴ and R³; R⁵ are each, independently of one another, a divalent to tetravalent bridge which may contain further heteroatoms and/or be substituted by nonionic radicals,
Y is SO₂—Y¹ or POY²Y³,
Y¹ is —O—R⁶, —NH—R⁶ or NR⁶R⁷,
Y²and Y³ are each, independently of one another, substituted or unsubstituted C₁-C₁₂-alkyl, substituted or unsubstituted C₆-C₁₀-aryl, a substituted or unsubstituted five- or six-membered pseudoaromatic or aromatic heterocyclic radical, —O—R⁶, —NH—R⁶ or NR⁶R⁷, or Y² and Y³ together form a bridge,
R⁶ and R⁷ are each, independently of one another, substituted or unsubstituted C₁-C₁₂-alkyl, substituted or unsubstituted C₃-C₈-cycloalkyl, substituted or unsubstituted C₂-C₁₂-alkenyl, substituted or unsubstituted C₂-C₁₂-alkynyl, substituted or unsubstituted C₇-C₁₂-aralkyl, substituted or unsubstituted C₆-C₁₀-aryl or a five- or six-membered heterocyclic ring or
NR⁶R⁷ together with the nitrogen atom is a five- to seven-membered heterocyclic ring which may contain further heteroatoms and/or be substituted by nonionic radicals.

20. A process for preparing an azo compound of the formula (Ic), as claimed in claim 15, characterized in that an aminoheterocycle of the formula (IV) 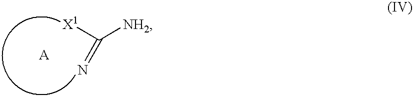
in which
X¹ is N—H,
A together with X¹ and N forms a five- or six-membered aromatic or pseudoaromatic heterocyclic ring which contains from 1 to 4 heteroatoms and/or may be benzo- or naphtho-fused and/or be substituted by nonionic radicals,
is diazotized or nitrosated and coupled with a coupling component of the formula (V) 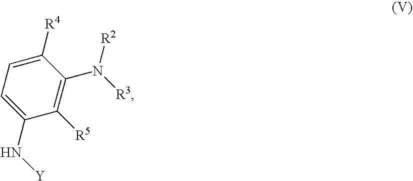
where
R² and R³ are each, independently of one another, hydrogen, substituted or unsubstituted C₁-C₁₂-alkyl, substituted or unsubstituted C₃-C₈-cycloalkyl, substituted or unsubstituted C₂-C₁₂-alkenyl, substituted or unsubstituted C₂-C₁₂-alkynyl, substituted or unsubstituted C₇-C₁₂-aralkyl, substituted or unsubstituted C₆-C₁₀-aryl or a five- or six-membered heterocyclic ring or
NR²R³ together with the nitrogen atom is a five- to seven-membered heterocyclic ring which may contain further heteroatoms and/or be substituted by nonionic radicals,
R⁴ and R⁵ are each, independently of one another, hydrogen, halogen, substituted or unsubstituted C₁-C₆-alkyl, substituted or unsubstituted C₁-C₆-alkoxy or substituted or unsubstituted C₁-C₆-alkylthio or
R²; R⁴ and R³; R⁵ are each, independently of one another, a divalent to tetravalent bridge which may contain further heteroatoms and/or be substituted by nonionic radicals,
Y is SO₂—Y¹ or POY²Y³,
Y¹ is —O—R⁶, —NH—R⁶ or NR⁶R⁷,
Y²and Y³ are each, independently of one another, substituted or unsubstituted C₁-C₁₂-alkyl, substituted or unsubstituted C₆-C₁₀-aryl, a substituted or unsubstituted five- or six-membered pseudoaromatic or aromatic heterocyclic radical, —O—R⁶, —NH—R⁶ or NR⁶R⁷, or Y² and Y³ together form a bridge,
R⁶ and R⁷ are each, independently of one another, substituted or unsubstituted C₁-C₁₂-alkyl, substituted or unsubstituted C₃-C₈-cycloalkyl, substituted or unsubstituted C₂-C₁₂-alkenyl, substituted or unsubstituted C₂-C₁₂-alkynyl, substituted or unsubstituted C₇-C₁₂-aralkyl, substituted or unsubstituted C₆-C₁₀-aryl or a five- or six-membered heterocyclic ring or
NR⁶R⁷ together with the nitrogen atom is a five- to seven-membered heterocyclic ring which may contain further heteroatoms and/or be substituted by nonionic radicals,
and the product is subsequently reacted with an alkylating agent of the formula
R¹-Z (VI),
where
R¹ is substituted or unsubstituted C₁-C₁₂-alkyl, substituted or unsubstituted C₃-C₈-cycloalkyl, substituted or unsubstituted C₂-C₁₂-alkenyl or substituted or unsubstituted C₇-C₁₂-aralkyl,
and
Z is a leaving group,
preferably in the presence of a basic substance.

22. A coupling component of the formula (V) 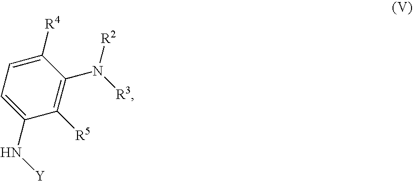
where
R² and R³ are each, independently of one another, hydrogen, substituted or unsubstituted C₁-C₁₂-alkyl, substituted or unsubstituted C₃-C₈-cycloalkyl, substituted or unsubstituted C₂-C₁₂-alkenyl, substituted or unsubstituted C₂-C₁₂-alkynyl, substituted or unsubstituted C₇-C₁₂-aralkyl, substituted or unsubstituted C₆-C₁₀-aryl or a five- or six-membered heterocyclic ring or
NR²R³ together with the nitrogen atom is a five- to seven-membered heterocyclic ring which may contain further heteroatoms and/or be substituted by nonionic radicals,
R⁴ and R⁵ are each, independently of one another, hydrogen, halogen, substituted or unsubstituted C₁-C₆-alkyl, substituted or unsubstituted C₁-C₆-alkoxy or substituted or unsubstituted C₁-C₆-alkylthio or
R²; R⁴ and R³; R⁵ are each, independently of one another, a divalent to tetravalent bridge which may contain further heteroatoms and/or be substituted by nonionic radicals,
Y is SO₂—Y¹ or POY²Y³,
Y¹ is —O—R⁶, —NH—R⁶ or NR⁶R⁷,
Y² and Y³ are each, independently of one another, substituted or unsubstituted C₁-C₁₂-alkyl, substituted or unsubstituted C₆-C₁₀-aryl, a substituted or unsubstituted five- or six-membered pseudoaromatic or aromatic heterocyclic radical, —O—R⁶, —NH—R⁶ or NR⁶R⁷, or Y² and Y³ together form a bridge,
R⁶ and R⁷ are each, independently of one another, substituted or unsubstituted C₁-C₁₂-alkyl, substituted or unsubstituted C₃-C₈-cycloalkyl, substituted or unsubstituted C₂-C₁₂-alkenyl, substituted or unsubstituted C₂-C₁₂-alkynyl, substituted or unsubstituted C₇-C₁₂-aralkyl, substituted or unsubstituted C₆-C₁₀-aryl or a five- or six-membered heterocyclic ring or
NR⁶R⁷ together with the nitrogen atom is a five- to seven-membered heterocyclic ring which may contain further heteroatoms and/or be substituted by nonionic radicals.

23. A process for preparing a compound of the formula (V) as claimed in claim 22, which is characterized in that an m-phenylenediamine of the formula (VI) 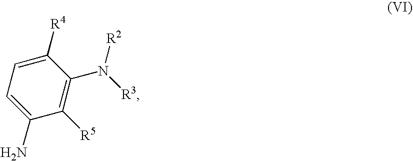
where
R² and R³ are each, independently of one another, hydrogen, substituted or unsubstituted C₁-C₁₂-alkyl, substituted or unsubstituted C₃-C₈-cycloalkyl, substituted or unsubstituted C₂-C₁₂-alkenyl, substituted or unsubstituted C₂-C₁₂-alkynyl, substituted or unsubstituted C₇-C₁₂-aralkyl, substituted or unsubstituted C₆-C₁₀-aryl or a five- or six-membered heterocyclic ring or
NR²R³ together with the nitrogen atom is a five- to seven-membered heterocyclic ring which may contain further heteroatoms and/or be substituted by nonionic radicals,
R⁴ and R⁵ are each, independently of one another, hydrogen, halogen, substituted or unsubstituted C₁-C₆-alkyl, substituted or unsubstituted C₁-C₆-alkoxy or substituted or unsubstituted C₁-C₆-alkylthio or
R²; R⁴ and R³; R⁵ are each, independently of one another, a divalent to tetravalent bridge which may contain further heteroatoms and/or be substituted by nonionic radicals,
is reacted with a sulfuric acid or phosphoric acid derivative of the formula
Z¹-SO₂—Y¹ (VII) or
Z¹-POY²Y³ (VIII)
where
Z¹ is chlorine or bromine,
Y¹ is —O—R⁶, —NH—R⁶ or NR⁶R⁷,
Y² and Y³ are each, independently of one another, substituted or unsubstituted C₁-C₁₂-alkyl, substituted or unsubstituted C₆-C₁₀-aryl, a substituted or unsubstituted five- or six-membered pseudoaromatic or aromatic heterocyclic radical, —O—R⁶, —NH—R⁶ or NR⁶R⁷, or Y² and Y³ together form a bridge,
R⁶ and R⁷ are each, independently of one another, substituted or unsubstituted C₁-C₁₂-alkyl, substituted or unsubstituted C₃-C₈-cycloalkyl, substituted or unsubstituted C₂-C₁₂-alkenyl, substituted or unsubstituted C₂-C₁₂-alkynyl, substituted or unsubstituted C₇-C₁₂-aralkyl, substituted or unsubstituted C₆-C₁₀-aryl or a five- or six-membered heterocyclic ring or
NR⁶R⁷ together with the nitrogen atom is a five- to seven-membered heterocyclic ring which may contain further heteroatoms and/or be substituted by nonionic radicals.

24. A process for preparing a compound of the formula (V) as claimed in claim 22 in which Y is POY²Y³, characterized in that an m-phenylenediamine of the formula (VI) 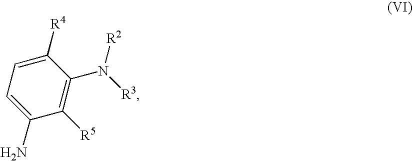
where
R² and R³ are each, independently of one another, hydrogen, substituted or unsubstituted C₁-C₁₂-alkyl, substituted or unsubstituted C₃-C₈-cycloalkyl, substituted or unsubstituted C₂-C₁₂-alkenyl, substituted or unsubstituted C₂-C₁₂-alkynyl, substituted or unsubstituted C₇-C₁₂-aralkyl, substituted or unsubstituted C₆-C₁₀-aryl or a five- or six-membered heterocyclic ring or
NR²R³ together with the nitrogen atom is a five- to seven-membered heterocyclic ring which may contain further heteroatoms and/or be substituted by nonionic radicals,
R⁴ and R⁵ are each, independently of one another, hydrogen, halogen, substituted or unsubstituted C₁-C₆-alkyl, substituted or unsubstituted C₁-C₆-alkoxy or substituted or unsubstituted C₁-C₆-alkylthio or
R²; R⁴ and R³; R⁵ are each, independently of one another, a divalent to tetravalent bridge which may contain further heteroatoms and/or be substituted by nonionic radicals,
is reacted with a phosphinic acid derivative of the formula
HPOY²Y³ (IX) or
P(OH)Y²Y³ (X),
where
Y² and Y³ are each, independently of one another, —O—R⁶, —NH—R⁶ or NR⁶R⁷,
R⁶ and R⁷ are each, independently of one another, substituted or unsubstituted C₁-C₁₂-alkyl, substituted or unsubstituted C₃-C₈-cycloalkyl, substituted or unsubstituted C₂-C₁₂-alkenyl, substituted or unsubstituted C₂-C₁₂-alkynyl, substituted or unsubstituted C₇-C₁₂-aralkyl, substituted or unsubstituted C₆-C₁₀-aryl or a five- or six-membered heterocyclic ring or
NR⁶R⁷ together with the nitrogen atom is a five- to seven-membered heterocyclic ring which may contain further heteroatoms and/or be substituted by nonionic radicals,
in the presence of CCl₄ or CBrCl₃.

25. A process for preparing a compound of the formula (V) as claimed in claim 22 in which Y— is SO₂Y¹, which is characterized in that
an m-phenylenediamine of the formula (VI) 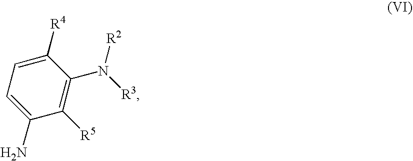
where
R² and R³ are each, independently of one another, hydrogen, substituted or unsubstituted C₁-C₁₂-alkyl, substituted or unsubstituted C₃-C₈-cycloalkyl, substituted or unsubstituted C₂-C₁₂-alkenyl, substituted or unsubstituted C₂-C₁₂-alkynyl, substituted or unsubstituted C₇-C₁₂-aralkyl, substituted or unsubstituted C₆-C₁₀-aryl or a five- or six-membered heterocyclic ring or
NR²R³ together with the nitrogen atom is a five- to seven-membered heterocyclic ring which may contain further heteroatoms and/or be substituted by nonionic radicals,
R⁴ and R⁵ are each, independently of one another, hydrogen, halogen, substituted or unsubstituted C₁-C₆-alkyl, substituted or unsubstituted C₁-C₆-alkoxy or substituted or unsubstituted C₁-C₆-alkylthio or
R²; R⁴ and R³; R⁵ are each, independently of one another, a divalent to tetravalent bridge which may contain further heteroatoms and/or be substituted by nonionic radicals,
is reacted with chlorosulfonic acid and subsequently with phosphorus pentachloride and this intermediate of the formula 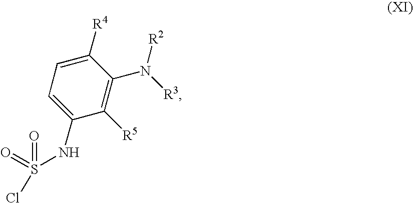
where R² to R⁵ are as defined above,
is reacted with an alcohol, phenol or amine of the formula
HOR⁶ (XII),
H₂NR⁶ (XIII) or
HNR⁶R⁷ (XIV),
where
R⁶ and R⁷ are each, independently of one another, substituted or unsubstituted C₁-C₁₂-alkyl, substituted or unsubstituted C₃-C₈-cycloalkyl, substituted or unsubstituted C₂-C₁₂-alkenyl, substituted or unsubstituted C₂-C₁₂-alkynyl, substituted or unsubstituted C₇-C₁₂-aralkyl, substituted or unsubstituted C₆-C₁₀-aryl or a five- or six-membered heterocyclic ring or
NR⁶R⁷ together with the nitrogen atom is a five- to seven-membered heterocyclic ring which may contain further heteroatoms and/or be substituted by nonionic radicals.

26. A solution of a metal complex as claimed in at least one of claims 1 to 10, characterized in that it contains at least 1% by weight of the metal complex and in that the solvent used is 2,2,3,3-tetrafluoropropanol, propanol, butanol, pentanol, hexanol, diacetone alcohol, dibutyl ether, heptanone or a mixture thereof.

27. The solution of a metal complex as claimed in claim 26 or 27, characterized in that the solvent used is propanol, butanol, pentanol, hexanol, diacetone alcohol or a mixture thereof.

28. The solution of a metal complex as claimed in claim 26, characterized in that the solvent used is a mixture of propanol/diacetone alcohol or butanol.

29. An optical data carrier comprising a preferably transparent substrate which may, if desired, have previously been coated with one or more reflection layers and to whose surface a light-writable information layer, if desired one or more reflection layers and if desired a protective layer or a further substrate or a covering layer have been applied, which can be written on and read by means of blue or red light, preferably laser light, where the information layer comprises a light-absorbent compound and, if desired, a binder, characterized in that at least one metal complex as claimed in at least one of claims 1 to 9 is used as light-absorbent compound.

30. The optical data carrier as claimed in claim 29, characterized in that the light-absorbent compound has the formula (Ia)
[(I)]₂⁻M²⁺ (Ia)
where the two ligands of the formula (I) have, independently of one another, one of the meanings given in claim 1 and
M is a metal, or
has the formula (Ib)
[(I)]₂⁻M³⁺An⁻ (Ib)
where the two ligands of the formula (I) have, independently of one another, one of the abovementioned meanings and
M is a metal and
An⁻ is an anion.

31. The optical data carrier as claimed in claim 30, characterized in that the metal M in the formula (Ia) is a divalent metal, transition metal or rare earth, in particular Mg, Ca, Sr, Ba, Cu, Ni, Co, Fe, Zn, Pd, Pt, Ru, Rh, Th, Os, Sm, Eu, and that in the formula (Ib) is a trivalent metal, transition metal or rare earth, in particular B, Al, Ga, In, V, Co, Cr, Fe, Y, La, Ce, Pr, Nd, Sm, Eu, Gd, Tb.

32. The optical data carrier as claimed in one or more of claims 29 to 31, characterized in that the light-absorbent compound used is a metal complex having an azo ligand of the formula (I), 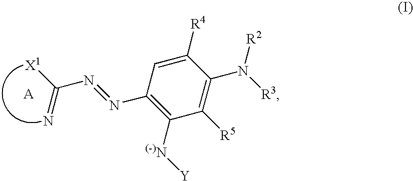
where
X¹ is O, S, N—R¹ or CH,
A together with X¹ and N forms a five- or six-membered aromatic or pseudoaromatic heterocyclic ring which contains from 1 to 4 heteroatoms and/or can be benzo- or naphtho-fused and/or be substituted by nonionic radicals,
R¹ is hydrogen, substituted or unsubstituted C₁-C₁₂-alkyl, substituted or unsubstituted C₃-C₈-cycloalkyl, substituted or unsubstituted C₂-C₁₂-alkenyl or substituted or unsubstituted C₇-C₁₂-aralkyl,
R² and R³ are each, independently of one another, hydrogen, substituted or unsubstituted C₁-C₁₂-alkyl, substituted or unsubstituted C₃-C₈-cycloalkyl, substituted or unsubstituted C₂-C₁₂-alkenyl, substituted or unsubstituted C₂-C₁₂-alkynyl, substituted or unsubstituted C₇-C₁₂-aralkyl, substituted or unsubstituted C₆-C₁₀-aryl or a five- or six-membered heterocyclic ring or
NR²R³ together with the nitrogen atom is a five- to seven-membered heterocyclic ring which may contain further heteroatoms and/or be substituted by nonionic radicals,
R⁴ and R⁵ are each, independently of one another, hydrogen, halogen, substituted or unsubstituted C₁-C₆-alkyl, substituted or unsubstituted C₁-C₆-alkoxy or substituted or unsubstituted C₁-C₆-alkylthio or
R²; R⁴ and R³; R⁵ are each, independently of one another, a divalent to tetravalent bridge which may contain further heteroatoms and/or be substituted by nonionic radicals,
Y is SO₂—Y¹ or POY²Y³,
Y¹ is —O—R⁶, —NH—R⁶ or NR⁶R⁷,
Y² and Y³ are each, independently of one another, substituted or unsubstituted C₁-C₁₂-alkyl, substituted or unsubstituted C₆-C₁₀-aryl, a substituted or unsubstituted five- or six-membered pseudoaromatic or aromatic heterocyclic radical, —O—R⁶, —NH—R⁶ or NR⁶R⁷, or Y² and Y³ together form a bridge,
R⁶ and R⁷ are each, independently of one another, substituted or unsubstituted C₁-C₁₂-alkyl, substituted or unsubstituted C₃-C₈-cycloalkyl, substituted or unsubstituted C₂-C₁₂-alkenyl, substituted or unsubstituted C₂-C₁₂-alkynyl, substituted or unsubstituted C₇-C₁₂-aralkyl, substituted or unsubstituted C₆-C₁₀-aryl or a five- or six-membered heterocyclic ring or
NR⁶R⁷ together with the nitrogen atom is a five- to seven-membered heterocyclic ring which may contain further heteroatoms and/or be substituted by nonionic radicals.

33. A process for producing the optical data carrier as claimed in claim 29, which is characterized in that a preferably transparent substrate which may, if desired, have previously been coated with a reflection layer is coated with a metal complex as claimed in claim 1, if desired in combination with suitable binders and additives and, if desired, suitable solvents, and provided, if desired, with a reflection layer, further intermediate layers and, if desired, a protective layer or a further substrate or a covering layer.

34. The optical data carrier as claimed in claim 29 which has been written on by means of blue or red light, in particular red light, especially red laser light.
